(19) United States
(12) Patent Application Publication
(10) Pub. No.: US 2007/0192145 A1
(43) Pub. Date: Aug. 16, 2007

(54) Computerized sales system program

(76) Inventor: Jason Hellickson, Cedar Rapids, IA (US)

Correspondence Address: Davis, Brown, Koehn, Shors & Roberts, P.C.;Suite 2500, The Financial Center, 666 Walnut Street, Des Moines, IA, 50309-3993, US

(21) Appl. No.: 11/352,158

(22) Filed: Feb. 10, 2006

(51) Int. Cl. G06Q 40/00

(52) U.S. Cl. 705/4

(57) ABSTRACT

A computerized sales system is provided. The system includes a general purpose computer system for performing the steps of the method in accordance with programming code operating on the computer; a graphical user interface for display of information and materials to a user of the system; a preparation step area of the graphical user interface for collection and presentation of tools and material intended for use in preparing for solicitation of a client by an offering firm; an open door step area of the graphical user interface for collection and presentation of tools and material intended for use in approaching the client or solicitation by the offering firm; a create credibility step area of the graphical user interface for collection and presentation of tools and materials intended of use in building credibility in the offering firm from the perspective of the client; and a create client step area of the graphical user interface for collection and presentation of tools and materials intended of use in creating a client relationship with the client.

### BACKGROUND OF THE INVENTION

The present invention relates to a computerized sales system program. In particular, the invention relates to a computerized implementation of a program for the collection and organization of information and material helpful to an offering organization in solicitation and engagement of a prospective client.

### SUMMARY OF THE INVENTION

An object of the present invention is providing an improved computerized system for solicitation of a prospective client.

These and other objects of the present invention will become apparent to those skilled in the art upon reference to the following specification, drawings, and claims.

The present invention intends to overcome the difficulties encountered heretofore. To that end, a computerized sales system is provided. The system includes a general purpose computer system for performing the steps of the method in accordance with programming code operating on the computer; a graphical user interface for display of information and materials to a user of the system; a preparation step area of the graphical user interface for collection and presentation of tools and material intended for use in preparing for solicitation of a client by an offering firm; an open door step area of the graphical user interface for collection and presentation of tools and material intended for use in approaching the client or solicitation by the offering firm; a create credibility step area of the graphical user interface for collection and presentation of tools and materials intended of use in building credibility in the offering firm from the perspective of the client; and a create client step area of the graphical user interface for collection and presentation of tools and materials intended of use in creating a client relationship with the client.

### BRIEF DESCRIPTION OF THE DRAWINGS

FIG. 1 is a screen shot of a company story sub-step of a preparation step of the present invention.

FIG. 2 is a screen shot of a brochures item screen of the company story sub-step of the preparation step of the present invention.

FIG. 3 is a screen shot of a company story item screen of the company story sub-step of the preparation step of the present invention.

FIG. 4 is a screen shot of a company website item screen of the company story sub-step of the preparation step.

FIG. 5 is a screen shot of a glossary of terms item screen of the company story sub-step of the preparation step of the present invention.

FIG. 6 is a screen shot of an AE bio and postcard item screen of the company story sub-step of the preparation step of the present invention.

FIG. 7 is a screen shot of a value proposition sub-step of the preparation step of the present invention.

FIG. 8 is a screen shot of a value proposition item screen of the value proposition sub-step of the preparation step of the present invention.

FIG. 9 [Reserved].

FIG. 10 is a screen shot of an industry practices value proposition item screen of the value proposition stub step of the preparation step of the present invention.

FIG. 11 is a screen shot of an independent validation sub-step of the preparation step of the present invention.

FIG. 12 is a screen shot of the first appointment-meeting item screen of the independent validation sub-step of the preparation step.

FIG. 13 is a screen shot of an interview item screen of the independent validation sub-step of the preparation step of the present invention.

FIG. 14 is a screen shot of a risk management report item screen of the independent validation sub-step of the preparation of the present invention.

FIG. 15 is a screen shot of a proposal-meeting item screen of the independent validation sub-step of the preparation step of the present invention.

FIG. 16 is a screen shot of a request for proposal sub-step of the preparation step.

FIG. 17 is a screen shot of a request forms item screen of the request for proposal sub-step of the preparation step of the present invention.

FIG. 18 is a screen shot of a responses-presentations item screen of the request for proposal sub-step of the preparation step of the present invention.

FIG. 19 is a screen shot of a suspect management sub-step of the preparation step of the present invention.

FIG. 20 is a screen shot of a solicitation process item screen of the suspect management sub-step of the preparation step of the present invention.

FIG. 21 is a screen shot of a pre-approach sub-step of an open door step of the present invention.

FIG. 22 is a screen shot of a pre-approach letter item screen of the pre-approach sub-step of the open door step of the present invention.

FIG. 23 is a screen shot of a seminar pieces item screen of the pre-approach sub-step of the open door step of the present invention.

FIG. 24 is a screen shot of a brochures item screen of the pre-approach sub-step of the open door step of the present invention.

FIG. 25 is a screen shot of a testimonials item screen of the pre-approach sub-step of the open door step.

FIG. 26 is screen shot of a captive pieces and value proposition item screen of the pre-approach step of the open door step of the present invention.

FIG. 27 is a screen shot of a company solver item screen of the pre-approach sub-step of the open door step of the present invention.

FIG. 28 is screen shot of an approach sub-step of the open door step of the present invention.

FIG. 29 is a screen shot of a talking pieces for cold calls item screen of the approach sub-step of the open door step of the present invention.

FIG. 30 is a screen shot of a thank you letters examples item screen of the approach sub-step of the open door step of the present invention.

FIG. 31 is a screen shot of an appointments sub-step of a create credibility step of the present invention.

FIG. 32 is a screen shot of an agenda item screen of the appointments sub-step of the create credibility step of the present invention.

FIG. 33 is a screen shot of a risk management report example item screen of the appointment sub-step of the create credibility step of the present invention.

FIG. 34 is screen shot of an independent validation articles item screen of the appointment sub-step of the create credibility step of the present invention.

FIG. 35 is a screen shot of a qualified prospects sub-step of the create credibility step of the present invention.

FIG. 36 is a screen shot of a competition engagement letter item screen of the qualified prospects sub-step of the create credibility step of the present invention.

FIG. 37 is a screen shot of a company competition plan item screen of the qualified prospect sub-step of the create credibility step of the present invention.

FIG. 38 is a screen shot of a risk management information request item screen of the qualified prospect sub-step of the create credibility step of the present invention.

FIG. 39 is a screen shot of a loss run release letter item screen of the qualified prospect sub-step of the create credibility step of the present invention.

FIG. 40 is a screen shot of a NCCI letter item screen of the qualified prospect sub-step of the create credibility step of the present invention.

FIG. 41 is a screen shot of a customer master item screen of the qualified prospect sub-step of the create credibility step of the present invention.

FIG. 42 is a screen shot of a captive bios item screen of the qualified prospect sub-step of the create credibility step of the present invention.

FIG. 43 is a screen shot of a thank you letter examples item screen of the qualified prospect sub-step of the create credibility step of the present invention.

FIG. 44 is a screen shot of an interviews sub-step of the create credibility step of the present invention.

FIG. 45 is a screen shot of a risk management survey item screen of the interview sub-step of the create credibility step of the present invention.

FIG. 46 is a screen shot of an independent validation item screen of the interviews sub-step of the create credibility step of the present invention.

FIG. 47 is a screen shot of a thank you letter examples item screen of the interview sub-step of the create credibility step of the present invention.

FIG. 48 is a screen shot of a risk management report sub-step of the create credibility step of the present invention.

FIG. 49 is a screen shot of an executive summary item screen of the risk management report sub-step of the create credibility step of the present invention.

FIG. 50 is a screen shot of a risk management report template item screen of the risk management report sub-step of the create credibility step of the present invention.

FIG. 51 is a screen shot of a loss summary item screen of the risk management report sub-step of the create credibility step of the present invention.

FIG. 52 is a screen shot of a data analysis item screen of the risk management report sub-step of the create credibility step of the present invention.

FIG. 53 is a screen shot of an experience modification item screen of the risk management report sub-step of the create credibility step of the present invention.

FIG. 54 is a screen shot of a triangles item screen of the risk management report sub-step of the create credibility step of the present invention.

FIG. 55 is a screen shot of a loss control service plan item screen of the risk management report sub-step of the create creditability step of the present invention.

FIG. 56 is a screen shot of a claim management item screen of the risk management report sub-step of the create credibility step of the present invention.

FIG. 57 is a screen shot of a contractual risk summaries item screen of the risk management report sub-step of the create credibility step of the present invention.

FIG. 58 is a screen shot of a coverage summary item screen of the risk management report sub-step of the create credibility step of the present invention.

FIG. 59 is a screen shot of a policy summary item screen of the risk management report sub-step of the create credibility step of the present invention.

FIG. 60 is a screen shot of a service plan item screen of the risk management report sub-step of the create credibility step of the present invention.

FIG. 61 is a screen shot of an exposure schedules item screen of the risk management report sub-step of the create credibility step of the present invention.

FIG. 62 is a screen shot of the required renewal applications item screen of the risk management report sub-step of the create credibility step of the present invention.

FIG. 63 is a screen shot of a premium history item screen of the risk management report sub-step of the create credibility step of the present invention.

FIG. 64 is a screen shot of a net cost item screen of the risk management report sub-step of the create credibility step of the present invention.

FIG. 65 is a screen shot of a security review item screen of the risk management report sub-step of the create credibility step of the present invention.

FIG. 66 is a screen shot of a benchmarking item screen of the risk management report sub-step of the create credibility step of the present invention.

FIG. 67 is a screen shot of a captive ROI item screen of the risk management report sub-step of the create credibility step of the present invention.

FIG. 68 is a screen shot of a career representations item screen of the risk management report sub-step of the create credibility step of the present invention.

FIG. 69 is a screen shot of a client narrative examples item screen of the risk management report sub-step of the create credibility step of the present invention.

FIG. 70 is a screen shot of a testimonials item screen of the risk management report sub-step of the create credibility step of the present invention.

FIG. 71 is a screen shot of a references item screen of the risk management report sub-step of the create credibility step of the present invention.

FIG. 72 is a screen shot of a risk management report follow up sub-step of the create credibility step of the present invention.

FIG. 73 is a screen shot of an audit saving letter item screen of the risk management report follow up sub-step of the create credibility step of the present invention.

FIG. 74 is screen shot of an independent validation item screen of the risk management report follow up sub-step of the create credibility step of the present invention.

FIG. 75 is a screen shot of a thank you letter examples item screen of the risk management report follow up sub-step of the create credibility step of the present invention.

FIG. 76 is a screen shot of a broker of record letters item screen of the risk management report follow up sub-step of the create credibility step of the present invention.

FIG. 77 is a screen shot of a captive conceptual item screen of the risk management report follow up sub-step of the create credibility step of the present invention.

FIG. 78 is a screen shot of a submit risk sub-step of the create credibility step of the present invention.

FIG. 79 is a screen shot of a submissions TOC item screen of the submit risk sub-step of the create credibility step of the present invention.

FIG. 80 is a screen shot of a carrier marketing list item screen of the submit risk sub-step of the create credibility step of the present invention.

FIG. 81 is a screen shot of a submissions examples item screen of the submit risk sub-step of the create credibility step of the present invention.

FIG. 82 is a screen shot of a marketing progress report sub-step of the create client step of the present invention.

FIG. 83 is a screen shot of a marketing progress report item screen of the marketing progress report sub-step of the create client step of the present invention.

FIG. 84 is a screen shot of a proposal sub-step of the create client step of the present invention.

FIG. 85 is a screen shot of a table of contents item screen of the proposal sub-step of the create client step of the present invention.

FIG. 86 is a screen shot of an executive summary item screen of the proposal sub-step of the create client step of the present invention.

FIG. 87 is a screen shot of a premium summery item screen of the proposal sub-step of the create client step of the present invention.

FIG. 88 is a screen shot of a transition plan item screen of the proposal sub-step of the create client step of the present invention.

FIG. 89 is a screen shot of a company team item screen of the proposal sub-step of the create client step of the present invention.

FIG. 90 is a screen shot of an independent validation item screen of the proposal sub-step of the create client step of the present invention.

FIG. 91 is a screen shot of a captive proposal item screen of the proposal sub-step of the create client step of the present invention.

FIG. 92 is a screen shot of a thank you letter examples item screen of the proposal sub-step of the create client sub-step of the present invention.

FIG. 93 is a screen shot of a service system installation sub-step of the create client step of the present invention.

FIG. 94 is a screen shot of an installation agenda item screen of the service system installation sub-step of the create client step of the present invention.

FIG. 95 is a screen shot of a thank you item screen of the service system installation sub-step of the create file step.

### DETAILED DESCRIPTION OF THE INVENTION

In the Figures is shown a computer software implementation of a sales system program. The program is implemented on one or more general-purpose computers, and preferably over a network of such computers. The preferred embodiment of the invention comprises a web based software application programmed in any convenient commercially available HTML programming language, which creates a graphical user interface implementation of the sales system. Of course, those of ordinary skill will understand that the invention is not so limited, and can be implemented in a variety of computerized environments and programming languages.

The sales system program is a computerized implementation of a tools based approach to sales or selling of goods, but most preferably services, and most preferably to selling insurance service products. The sales program is broken down into a series of steps or processes. With each step an area of further tools or services are provided in the form of sub-steps to assist with successful completion of the particular step or process. In this manner, the sales system program provides a systematic method of approaching sales tasks and creates a computerized environment for the collection of tools necessary and helpful for completing each step, and sub-step.

In particular, the first step of the system is the preparation step. This step involves gathering the assets necessary to begin the process of preparing material that can be used for approaching a prospective client, and identifying and documenting the aspects of the offering organization that are unique. This step is further divided into a plurality of further sub-steps, which will be described in detail herein-below.

The next step in the process is the open door step. In this step the system provides access to tools useful for initial client contact. This step is further divided into a plurality of further sub-steps, which will be described in detail herein-below.

Next, is the create credibility step. In this step the system provides access to tools useful for building credibility with the prospective client. This includes providing tools useful in developing a plan for the delivery of goods/service, gathering information from the prospective client, and for providing a request for proposal. This step is further divided into a plurality of further sub-steps, which will be described in detail herein-below.

The last step in the process is the create client step. In this step the system provides access to tools useful for delivering the agreed upon proposals, and for the introduction of key personal to the prospective client. This step is further divided into a plurality of further sub-steps, which will be described in detail herein-below.

In the preferred embodiment of the invention the sales system is implemented for a provider of insurance services, which will be described in detail in reference the Figures. The system, however, is not necessarily limited to insurance services. Those of ordinary skill in the art will understand and appreciate that the system is can and will be adapted to providers of goods and other services.

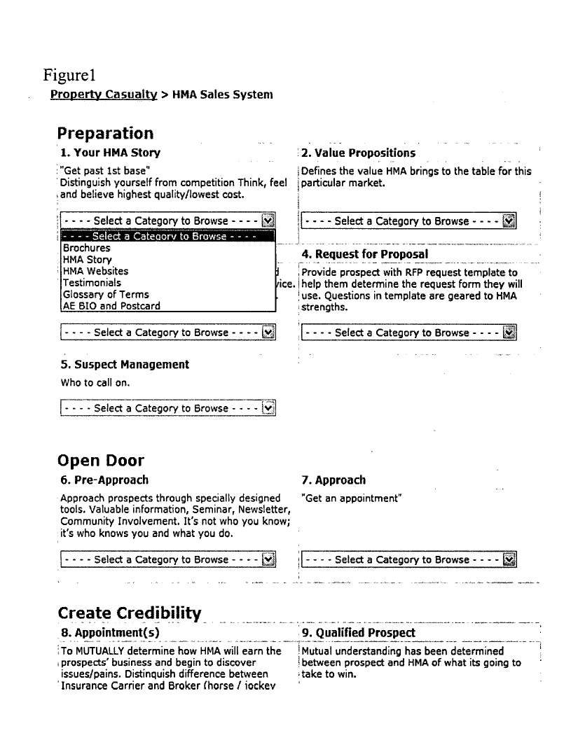

FIG. 1 shows a screen shot of computer software implementation of the sales system program. In particular, FIG. 1 shows a screen shot of the initial preparation step, and sub-steps. The preparation step is divided into five sub-steps, namely, the company story sub-step, the value propositions sub-step, the independent validations sub-step, the request for proposal sub-step, and the suspect management sub-step. Each sub-step includes a drop down menu for selecting the various items available for the particular sub-step. This structural pattern repeats for the other steps and sub-steps of the invention.

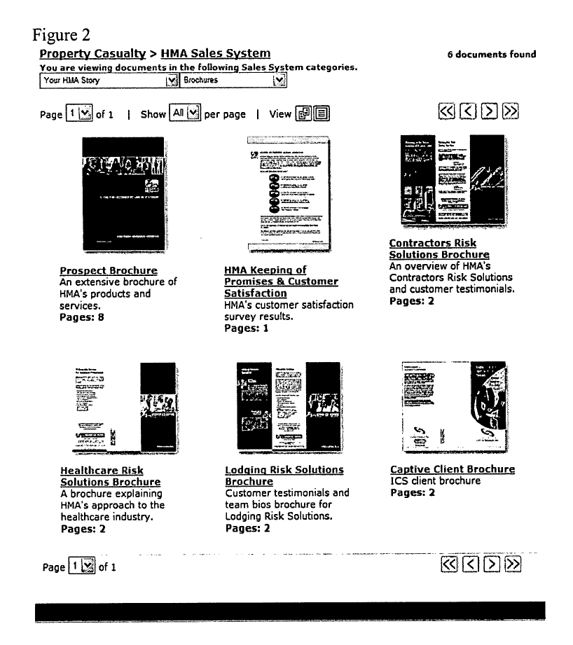

Referring to the company store sub-sep of the initial preparation step, selecting the brochures item listed in the drop down box under the your company story sub-step of the preparation step displays the screen shown in FIG. 2. This screen displays a plurality of company brochures that are available for use in the initial preparation step. The brochures can be accessed by highlighting and selecting the appropriate brochure, and as such are available as a tool for use in the initial phase of preparing sales and solicitation materials. These brochures are of a general nature containing information about the company, or about the dominant goods or services of the company, and would be useful in presenting a general overview of the company and its goods and services. As is described and sown herein-below, this method of thumbnail presentation of the prepared materials repeats for the remainder of the items screens.

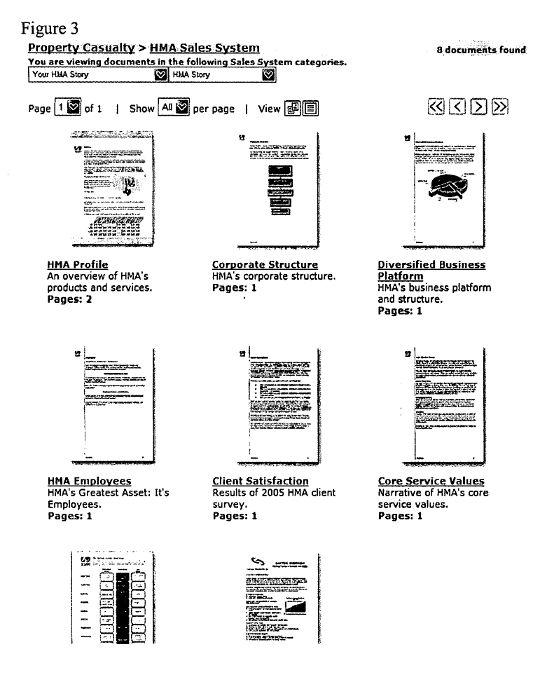

Selecting the company story item from the drop down box listed under the your company story sub-step of the preparation step displays the screen shown in FIG. 3. This screen displays available materials, publications, and tools useful in explaining particular aspects of the company's business including its history, its structure, its values, and other similar information that would be helpful or useful in preparing for initial contact with a prospective client.

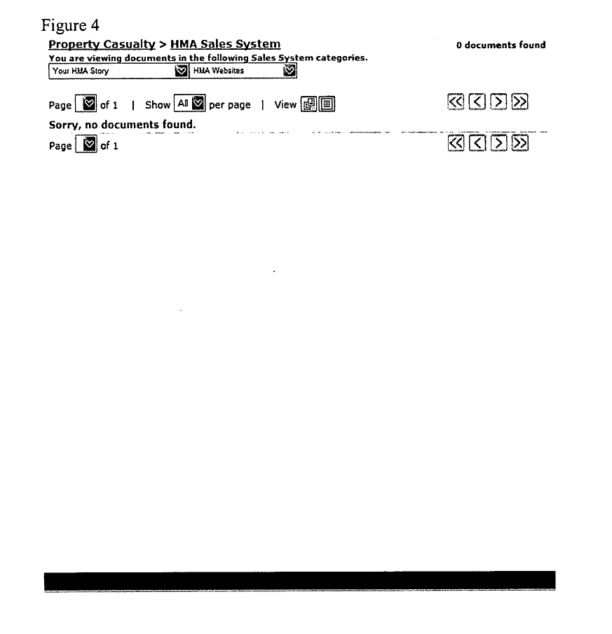

Selecting the company website's item from the drop down menu associated with the company story sub-step of the preparation step, displays the screen shown in FIG. 4. This screen can be used to display information about on the company's website that may be useful to a prospective client. Again, this information can be the same or different for other preparatory information, but is distinguished based on the availability over a large-scale computer network.

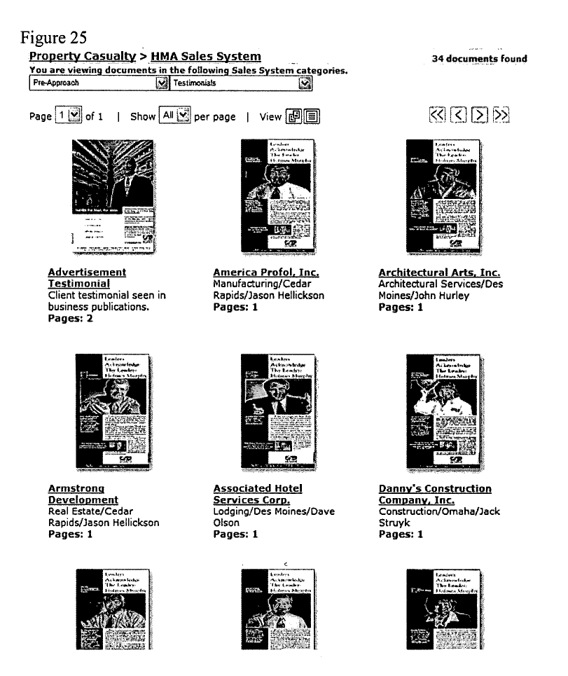

Selecting the testimonials option from the drop down menu associated with the company story sub-step of the preparation step will display a screen substantially identical to the screen shown in FIG. 25. This screen can display prepared materials in the form of testimonials from the company's other clients and customers that can be used for preparing materials for use in soliciting a prospective client. The individual testimonials can be selecting and reviewed by highlighting the thumbnail picture of the document, or written description of the document.

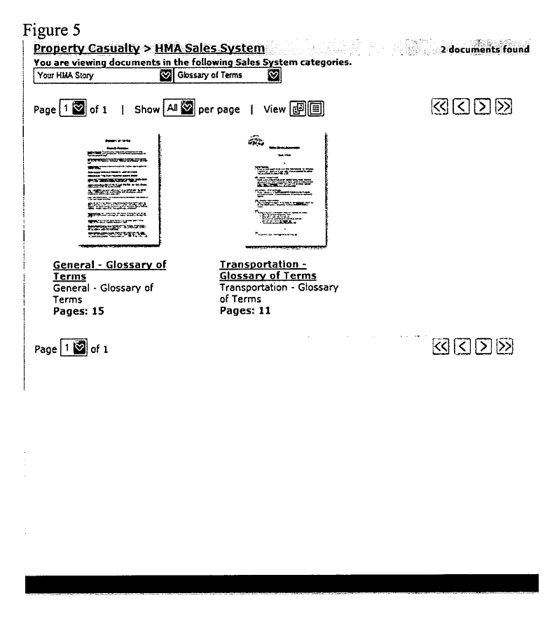

Selecting the glossary of terms item from the drop down menu listed under the company story sub-step of the preparation step displays the screen shown in FIG. 5. This screen can be used to list information that defines terms relevant to the particular expertise of the company involved. The individual documents can be selected by highlighting the picture of the document or the text appearing below the document. This information can be useful in educating a prospective client in the meaning of specific terms, principals, or concepts used in the area of practice.

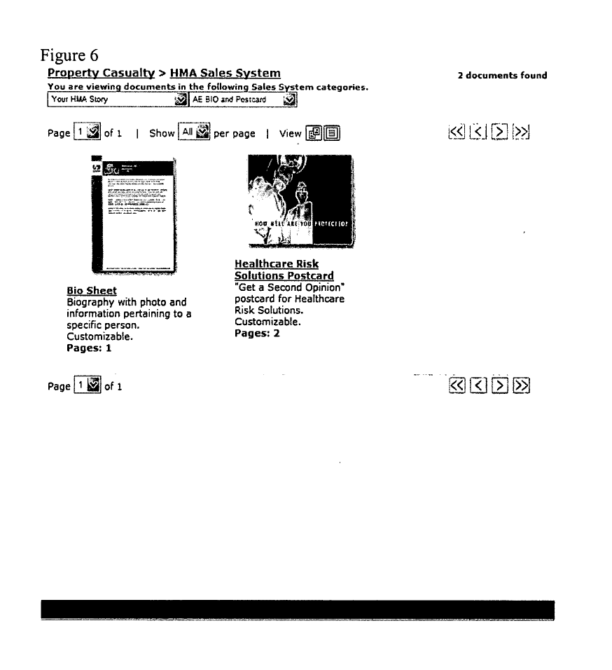

Selecting the AE bio and postcard item in the drop down menu of the company story sub-step of the preparation step displays the screen shown in FIG. 6. This screen displays biographical information, and informational postcards that can be used in preparation materials to submit to a prospective client.

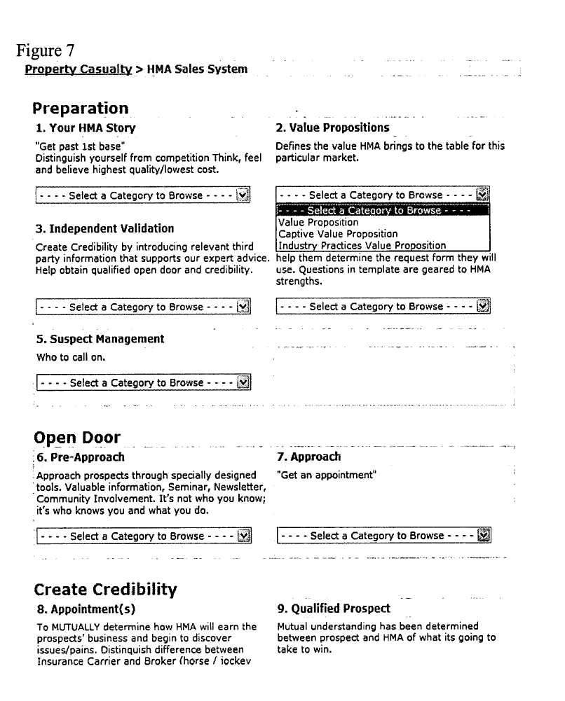

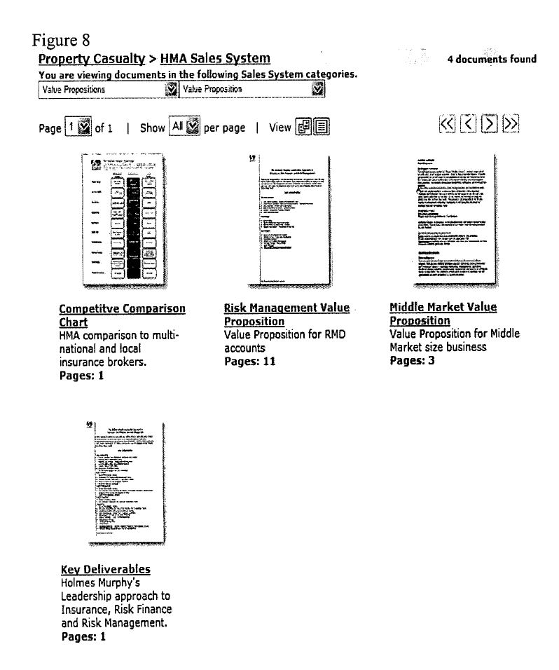

FIG. 7 displays the drop down menu associated with the value propositions sub-step of the preparation step. The value propositions sub-step collects together materials that define the value of the organization in its particular market. Selecting the value proposition item in the drop down menu under the value propositions sub-step of the preparation step displays the screen shown in FIG. 8. This screen displays various materials that highlight the competitive advantages and particular qualities of the organization making the sales presentation. These items can be used to convey valuable information to a prospective client. Again, as is the situation with the other menus, highlighting the document or the document description allows for selecting the particular document for display.

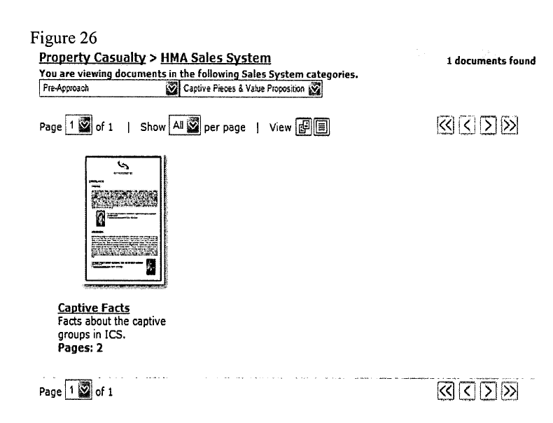

Selecting the captive value proposition item in the drop down menu associated with the value proposition sub-step of the preparation step displays a screen similar to the screen shown in FIG. 26. This screen displays information specific to the most preferred embodiment of the invention, namely, insurance services. The screen displays a fact sheet relating to captive insurance companies, which are closely held insurance companies whose insurance business is primarily supplied by and controlled by its owners, and in which the original insurers insured's are the principal beneficiaries. In other words, a captive is an insurance company formed exclusively to insure the insurance risks of its parent corporation. Of course, in other applications the specific information can and will vary.

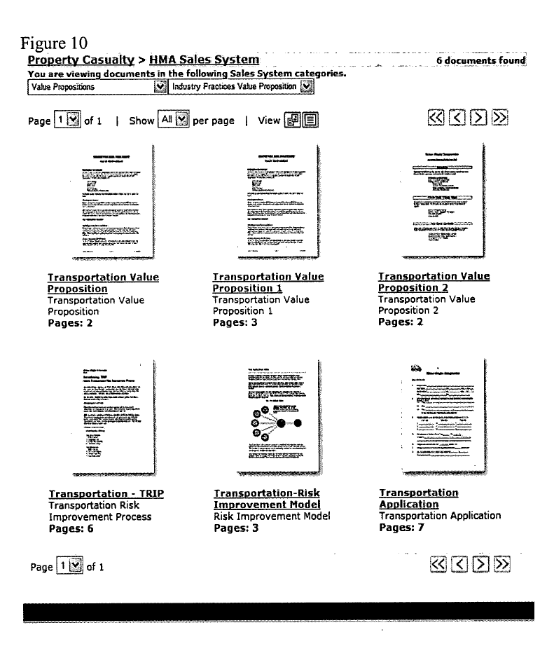

Selecting the industry practices value proposition item from the drop down menu shown in association with the value propositions sub-step of the preparation step will display the screen shown in FIG. 10. This screen displays information specific to various industries, or target areas of the offering company. This information is helpful in distinguishing the offering firm by providing information highly specific to the prospective customer.

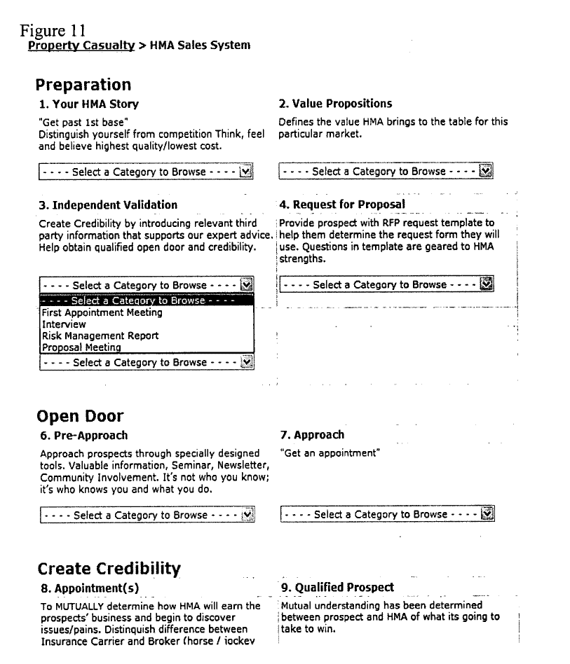

FIG. 11 shows a drop down menu associated with an independent validation sub-step of the preparation step. In this step third party research information and support tools are made available for use in the process of preparation of sales solicitation.

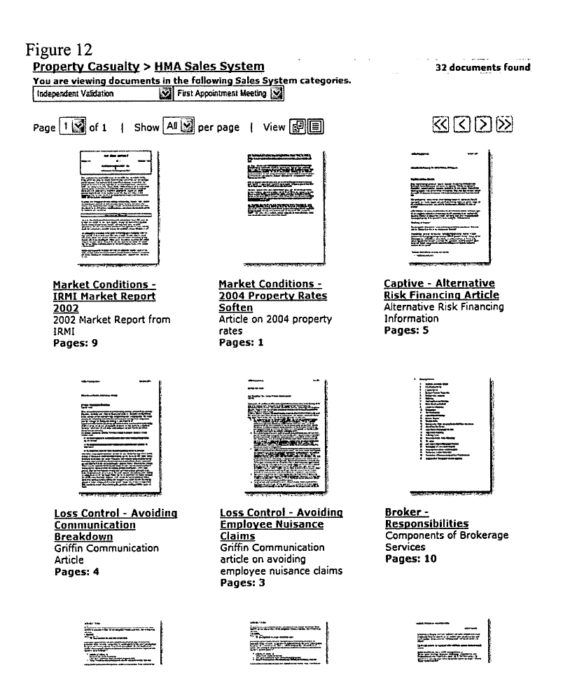

In particular, selecting the first appointment-meeting item in the drop down menu associated with the independent validation sub-step of the preparation step display the screen shown in FIG. 12. This screen displays various prepared third party materials relevant to the market and business area of the offering company. These materials can be used in an initial client meeting.

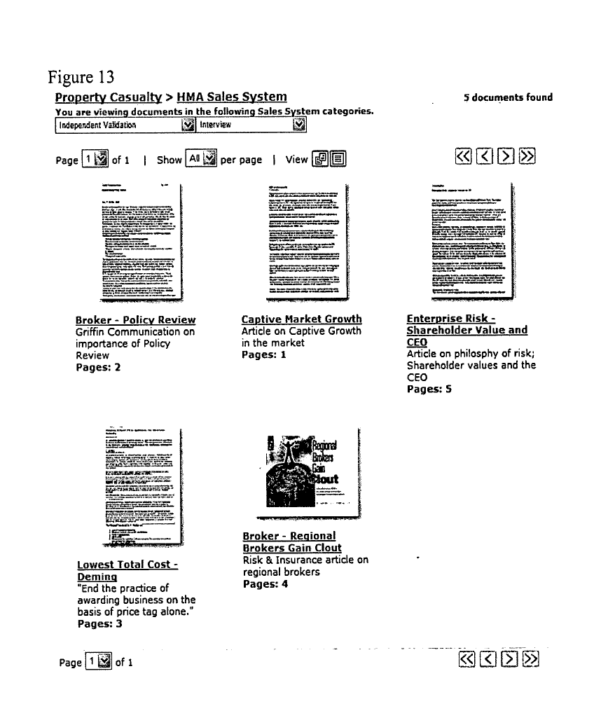

Selecting the interview item from the drop down menu associated with the independent validation sub-step of the preparation step displays the screen shown in FIG. 13. The information displayed in FIG. 13 is helpful in initial client contact situations, and provides information about the offering companies polices, procedures, specialized skills, and goods/services offerings.

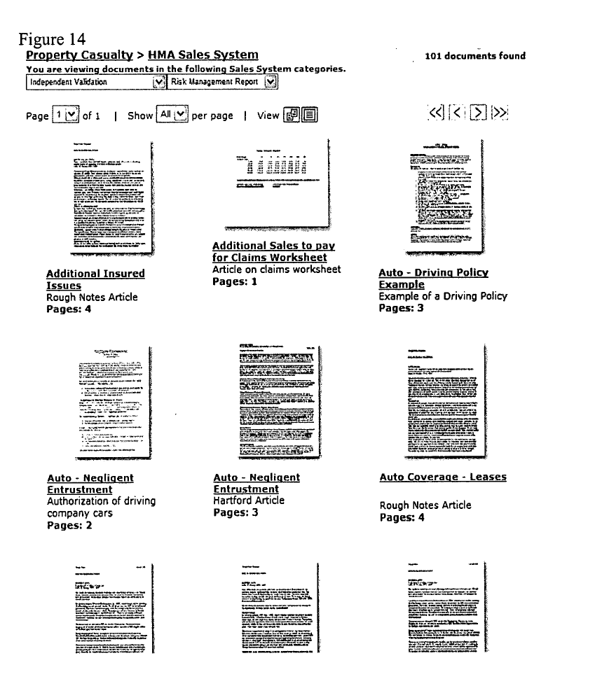

Selecting the risk management report item from the drop down menu associated with the independent validation sub-step of the preparation step displays the screen shown in FIG. 14. This screen shows information particularly related to the most preferred embodiment of the invention, namely, insurance services. Of course, those of ordinary skill in the art will understand that the information presented on this screen can and will vary depending on the specialization of the offering firm. In reference to the preferred embodiment of the invention, the information on FIG. 14 includes information about specific areas of insurance coverage that may be relevant to a particular prospective client.

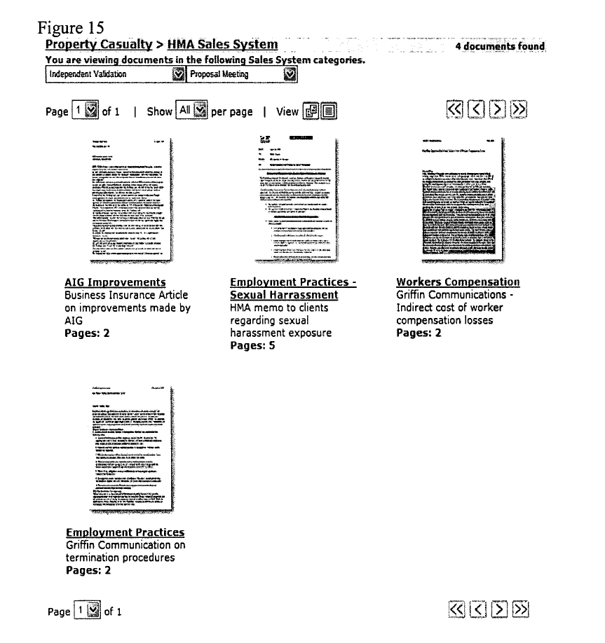

Selecting the proposal-meeting item from the drop menu associated with the independent validation sub-step of the preparation step displays the screen shown in FIG. 15. This screen shows information useful in a first meeting, and specific to proposals made in a first meeting with a prospective client.

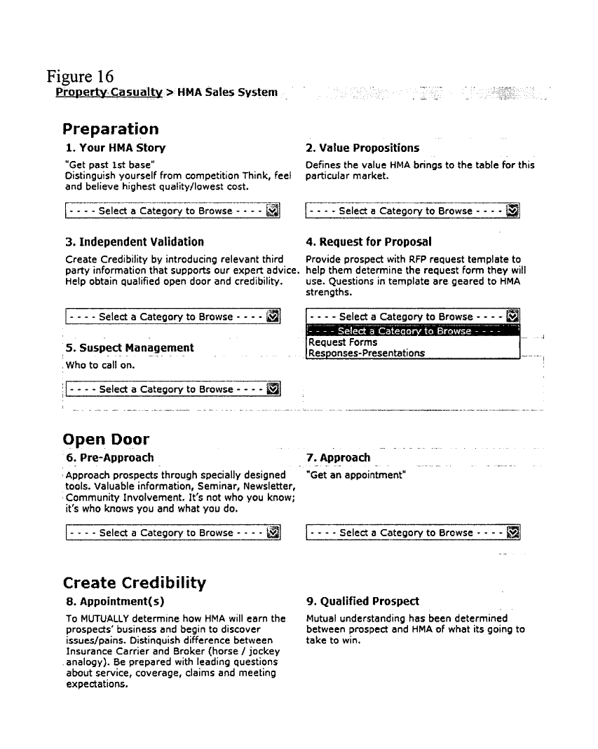

FIG. 16 displays the drop down menu associated with the request for proposal sub-step of the preparation step. In this step, information and tools are collected to assist in the process of generating a request for proposal tailored to a specific prospective client.

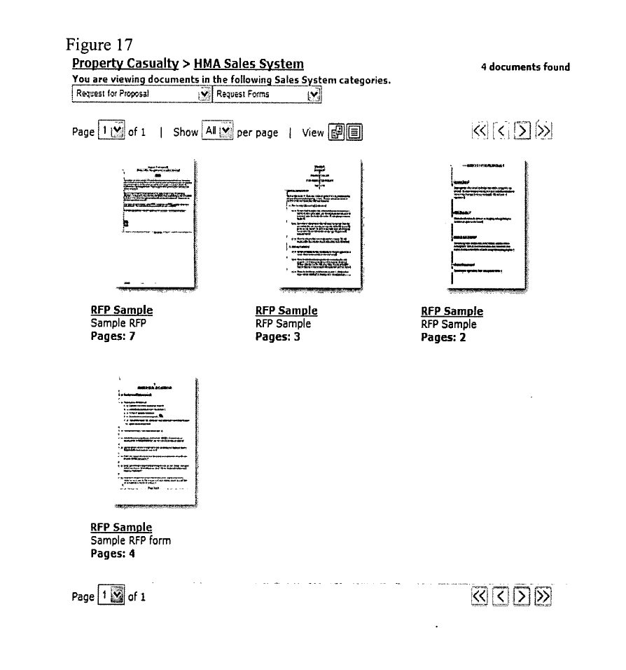

In particular, selecting the request forms item from the drop down menu associated with the request for proposal sub-step of the preparation step displays the screen shown in FIG. 17. The information shown in FIG. 17 includes sample cover letters and request for proposal forms that may meet the needs of the particular prospective client.

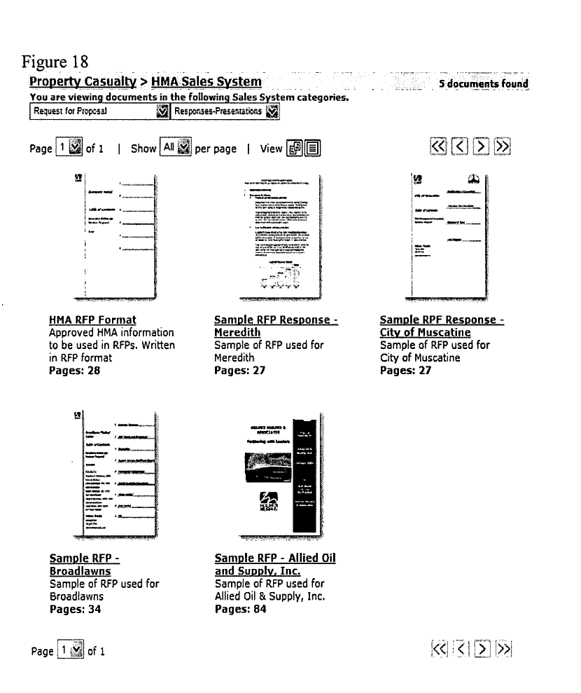

Selecting the responses-presentations item from the drop down menu associated with the request for proposal sub-step of the preparation step displays the screen shown in FIG. 18. FIG. 18 displays request for proposal forms, or previously used request for proposal forms that can be used or modified to meet the needs of a particular prospective client.

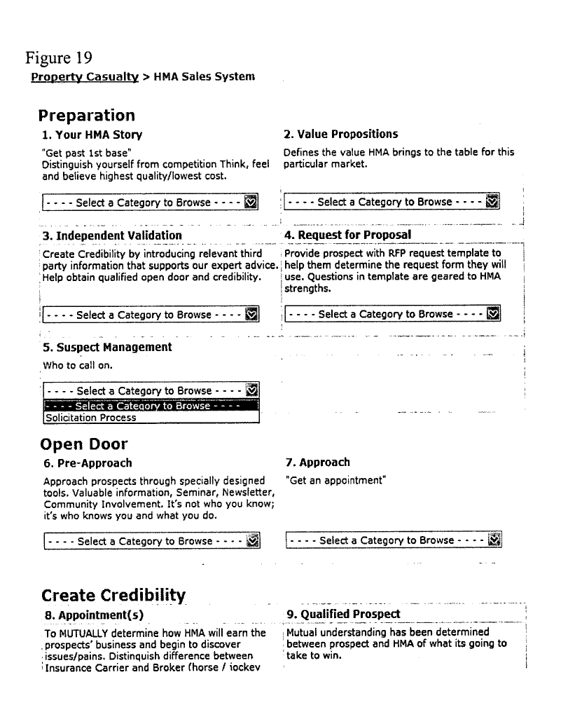

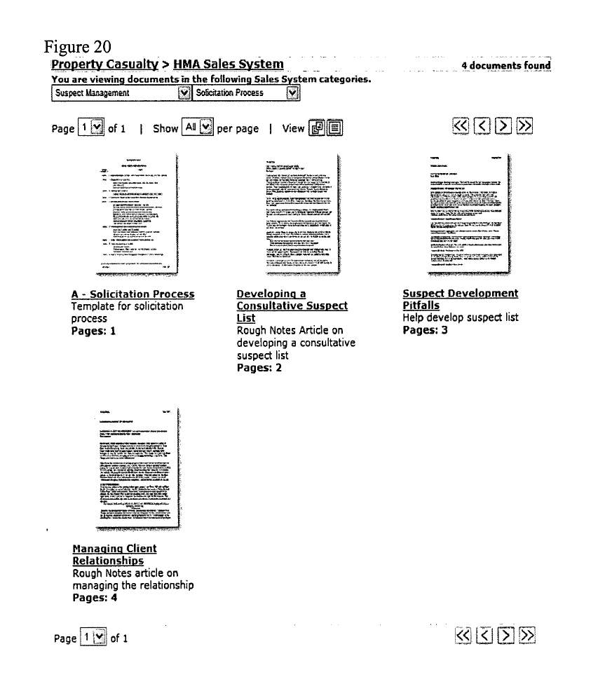

FIG. 19 displays a drop down menu associated with a suspect management sub-step of the preparation step. The suspect management sub-step allows for the collection of information and tools useful in managing prospective clients and techniques for identifying prospective clients.

In particular, selecting the solicitation process item from the drop down menu associated with the suspect management sub-step of the preparation step displays the screen shown in FIG. 20. FIG. 20 displays information helpful in the sales solicitation process, in identifying prospective clients, development of strategies and insights helpful in initial client contact, and information about managing client relationships.

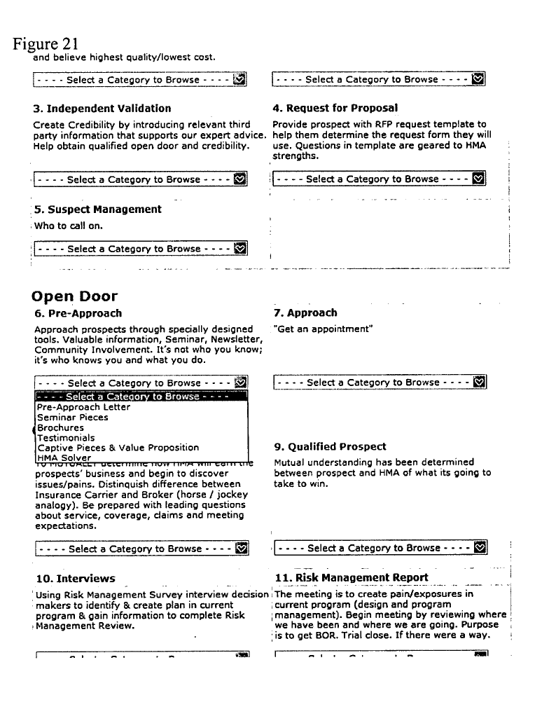

The second step in the process comprises the open door step. This step divides into several sub-steps the process of identifying what materials to use in the solicitation process, and preparing those materials for presentation to a prospective client. The first sub-step in the open door step is the pre-approach step. FIG. 21 displays a drop down menu associated with the pre-approach sub-step of the open door step.

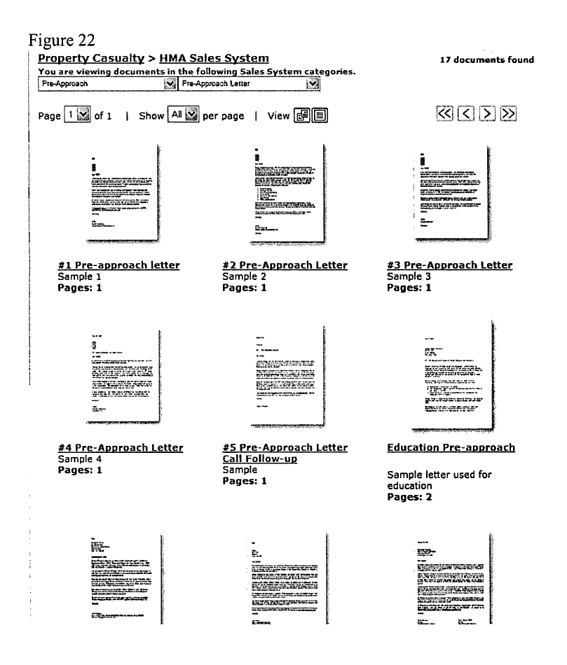

Selecting the pre-approach letter item in the drop down menu associated with the pre-approach sub-step of the open door step displays the screen shown in FIG. 22. FIG. 22 displays various template/sample form letters that can be used to make initial contact with a prospective customer for the purpose of introduction, and setting up an initial meeting.

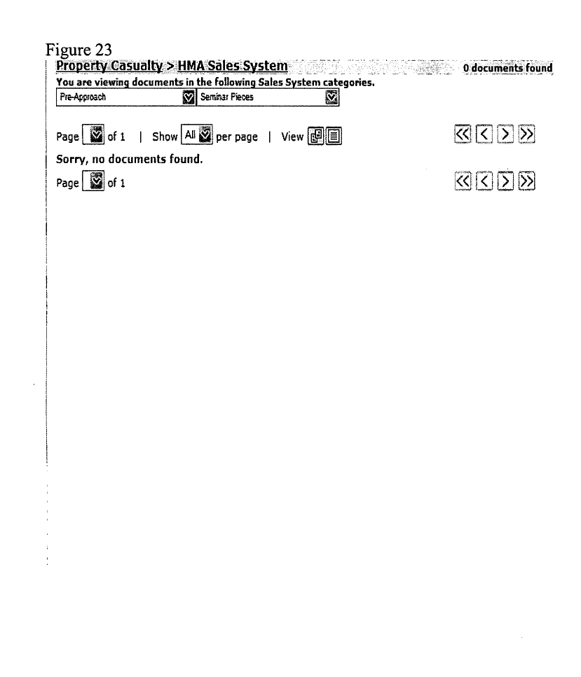

Selecting the seminar pieces item from the drop down menu associated with the pre-approach sub-step of the open door step displays the screen shown in FIG. 23. FIG. 23 can be used to display presentations and seminar materials that may be useful or of interest to a specific prospective customer and can be provided to the prospective customer in an initial contact letter or meeting.

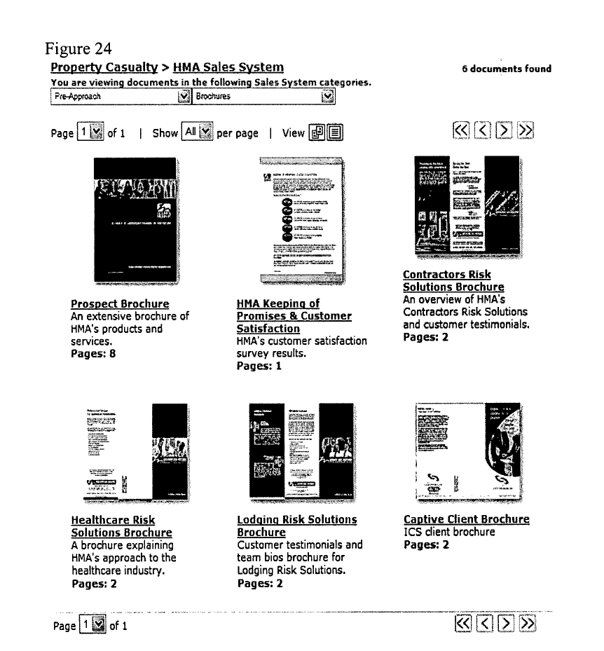

Selecting the brochures item from the drop down menu associated with the pre-approach sub-step of the open door step displays the screen shown in FIG. 24. FIG. 24 displays various pre prepared brochures and marketing material that feature and highlight the offering companies services and specialized expertise, which can be provided to a prospective client upon initial contact.

Selecting the testimonials item from the drop down menu associated with the pre-approach sub-step of the open door step displays the screen shown in FIG. 25. FIG. 25 displays various testimonial information from the offering companies current and existing clients that may be helpful and useful in the initial solicitation process of a prospective client.

Selecting the captive pieces and value proposition item from the drop down menu associated with the pre-approach sub-step of the open door step displays the screen shown in FIG. 26. FIG. 26 displays information related to the most preferred embodiment of the application, namely, insurance services. In particular, information related to insurance services in the form of information about captive groups. Captive groups are utilized in insurance services in certain situations, as described herein-above.

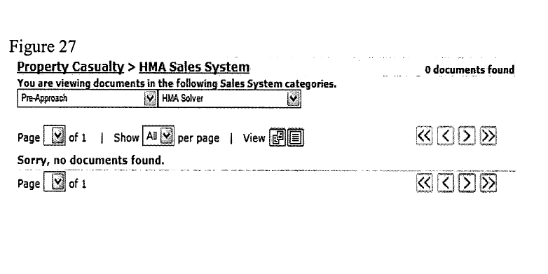

Selecting the company solver item from the drop down menu associated with the pre-approach sub-step of the open door step displays the screen in FIG. 27. [what is this item???]

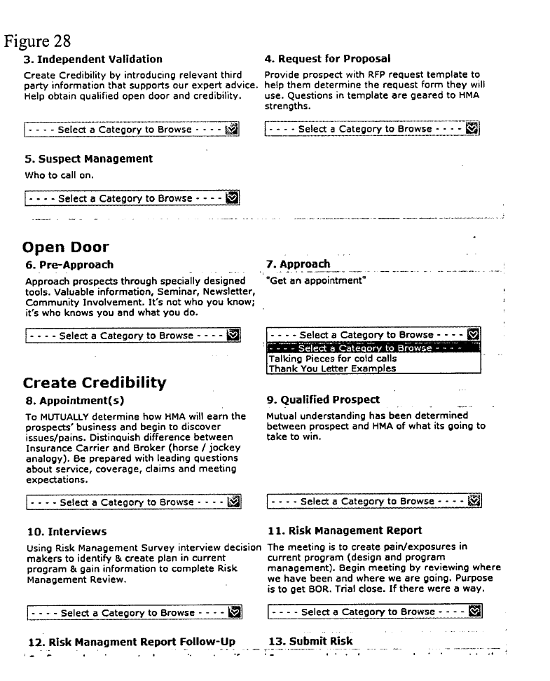

FIG. 28 shows the drop down menu associated with an approach sub-step of the open door step. This step provides the tools and information helpful in the actual process of initial contact with the prospective client.

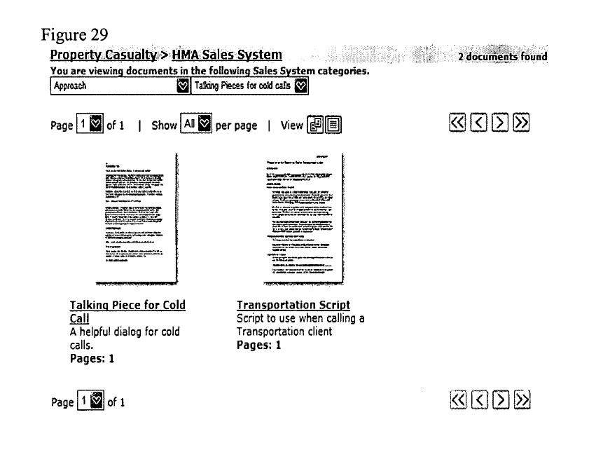

Selecting the talking pieces for cold calls item from the drop down menu associated with the approach sub-step of the open door step displays the screen shown in FIG. 29. FIG. 29 displays information that can be used in placing an initial call to a prospective client. In particular, the information provides useful techniques, strategies, and scripts helpful to a member of the offering firm in making an initial call to a prospective client.

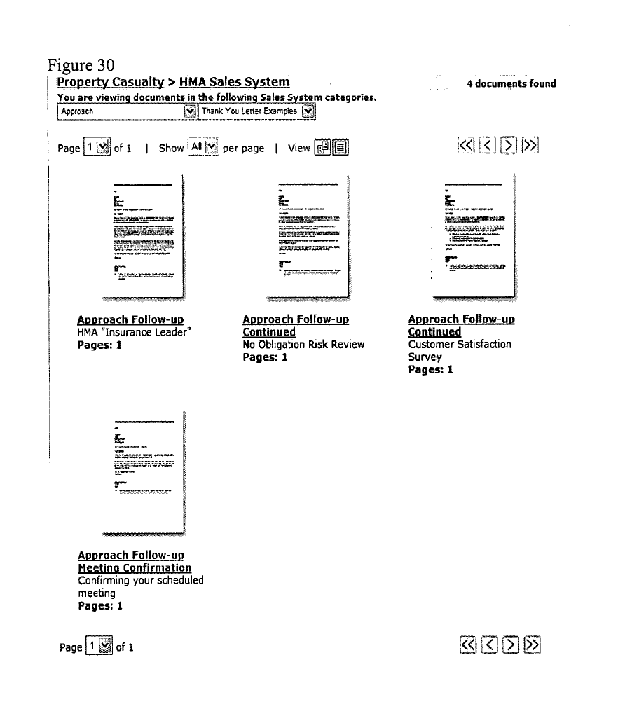

Selecting the thank you letter examples item from the drop down menu associated with the approach sub-step of the open door step displays the screen shown in FIG. 30. FIG. 30 displays information that can be used after an initial contact, or in association therewith to thank the prospective client for their consideration and also providing additional information about the offering company.

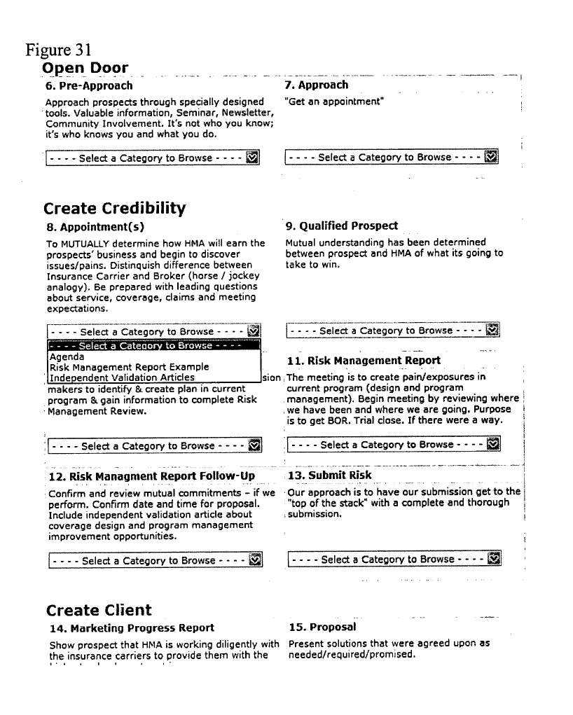

The third general step in the process is the create credibility step. In this step some form of initial contact has been made with the prospective client, and the offering firm now has the opportunity for further contact and in this step the tools useful in building a relationship with a prospective client and creating credibility with the prospective client are made available using the same general framework of the present invention described herein-above. In particular, FIG. 31 displays the create credibility step and sub-steps. The first sub-step is the appointments sub-step.

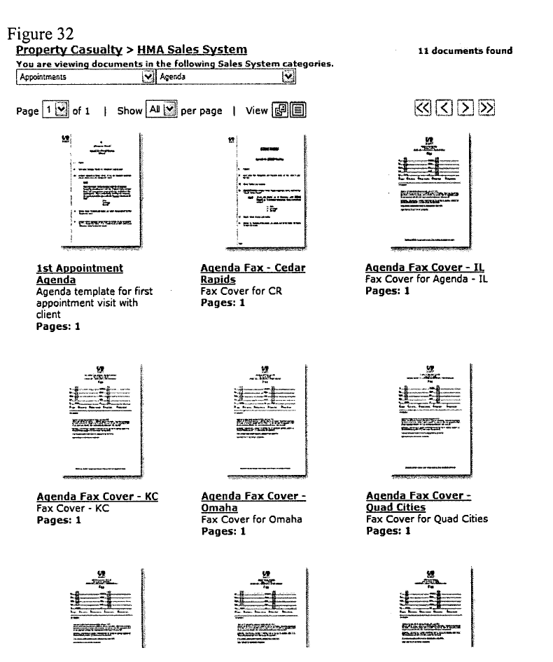

Selecting the agenda item from the drop down menu associated with the appointment sub-step of the create credibility step displays the screen in FIG. 32. FIG. 32 displays information that can be used to set agendas for a client meeting, or other meetings with a prospective client. Materials include pre prepared agendas, cover sheets, and the like.

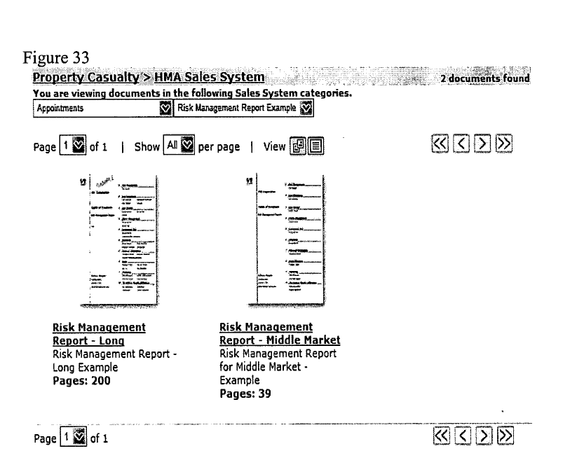

Selecting the risk management report example item from the drop down menu associated with the appointments sub-step of the create credibility step displays the screen shown in FIG. 33. FIG. 33 displays information related to the most preferred embodiment of the invention. In particular, the screen includes pre prepared materials regarding risk management reports of a type commonly used in the insurance service industry.

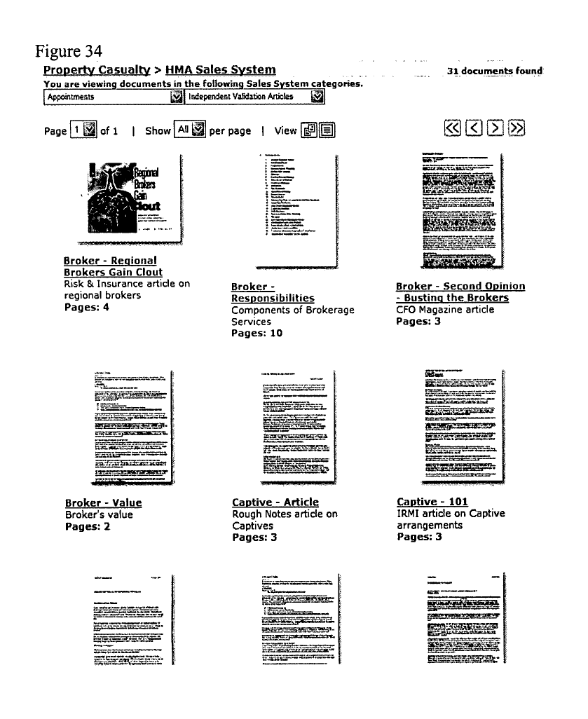

Selecting the independent validation articles item of the drop down menu associated with the appointment sub-step of the create credibility step displays the screen shown in FIG. 34. FIG. 34 lists information regarding third party reference material, and in particular information regarding the most preferred embodiment of the invention relating to insurance brokerage services and other validation articles specific to insurance services.

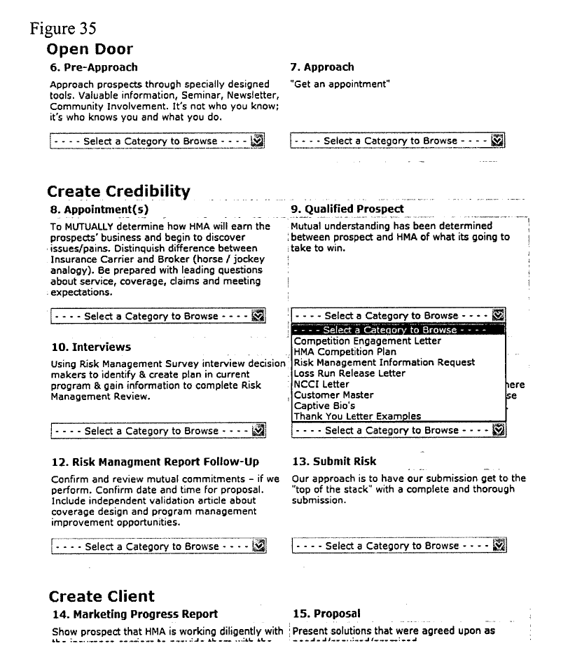

FIG. 35 shows the qualified prospect sub-step of the create credibility step. The qualified prospect sub-step gathers together the information necessary and helpful to develop a more specific proposal and plan to meet the needs of the prospective client.

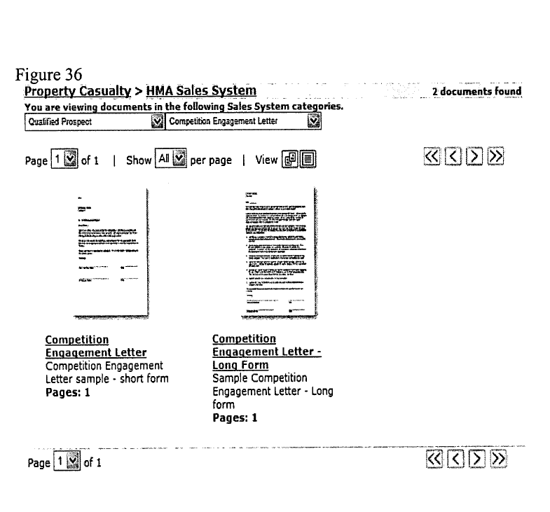

In particular, selecting the competition engagement letter item from the drop down menu associated with the qualified prospect sub-step of the create credibility step displays the screen shown in FIG. 36. The competition engagement letter sets out the specifics of the relationship between the prospective client and the offering firm, and information related to the anticipated scope of work of projects undertaken by the offering firm on behalf of the prospective client.

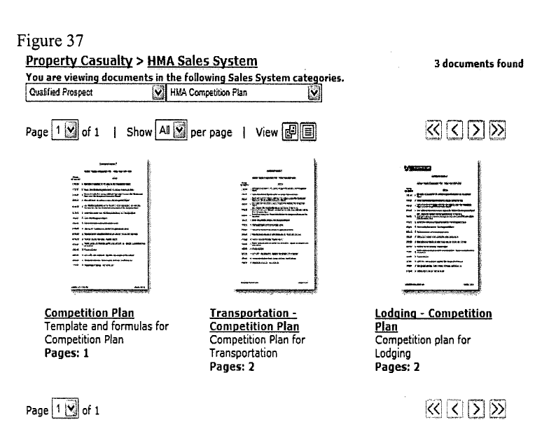

Selecting the competition plan item from the drop down menu associated with the qualified prospect sub-step of the create credibility step displays the screen shown in FIG. 37. This screen displays information that can be used to prepare a specific plan on how the offering firm proposes to serve the prospective client. Including, details of the proposed process and evolution of the relationship and services offered to the prospective client.

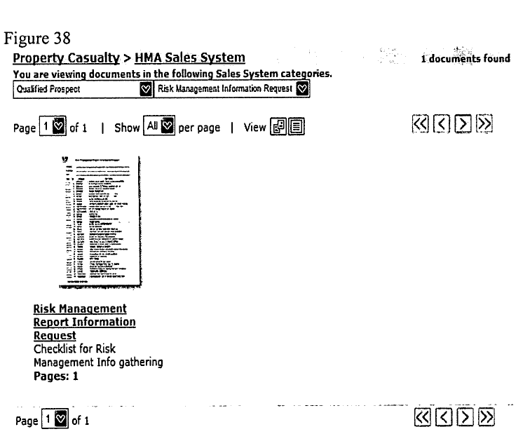

Selecting the risk management information request item from the drop down menu associated with the qualified prospect sub-step of the create credibility step displays the screen shown in FIG. 38. The information displayed on this screen is helpful in soliciting information from a prospective client that would allow for the preparation of a risk management report, which are commonly associated with the most preferred embodiment of the invention, namely insurance brokerage services.

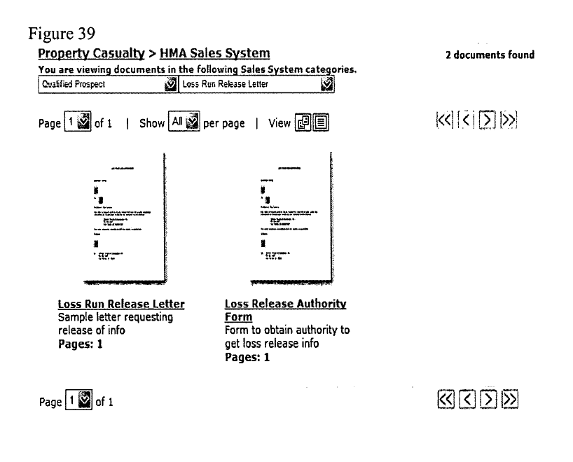

Selecting the loss run release letter item from the drop down menu associated with the qualified prospect sub-step of the create credibility step displays the screen shown in FIG. 39. This screen displays examples of release forms that can be used with a prospective client to authorize the offering firm to receive sensitive and proprietary information necessary to prepare the solicitation documents.

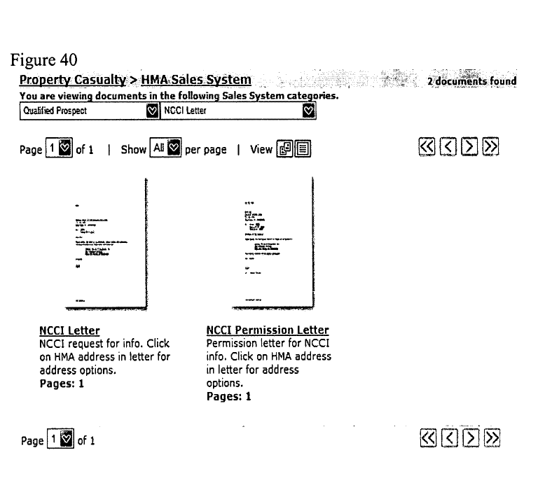

Selecting the NCCI letter item from the drop down menu associated with the qualified prospect sub-step of the create credibility step displays a screen shown in FIG. 40. This screen displays information relevant to the preferred embodiment of the invention, namely letters that can be sent to the prospective client to authorize release of information from the National Counsel on Compensation Insurance, which will allow the NCCI to release information about the prospective client to the offering firm.

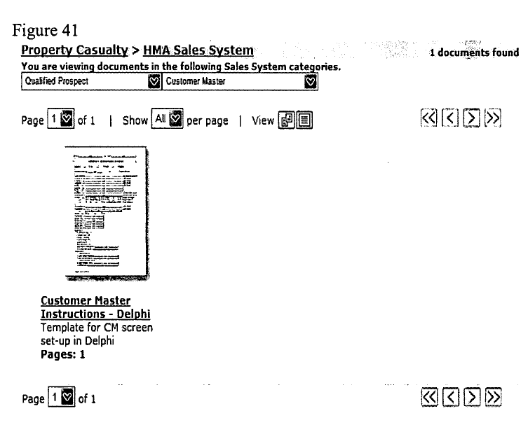

Selecting the customer master item from the drop down menu associated with the qualified prospect sub-step of the create credibility step displays the screen shown in FIG. 41. The screen displays templates that can be helpful in setting up organizational charts, contact information, and other information about the prospective client.

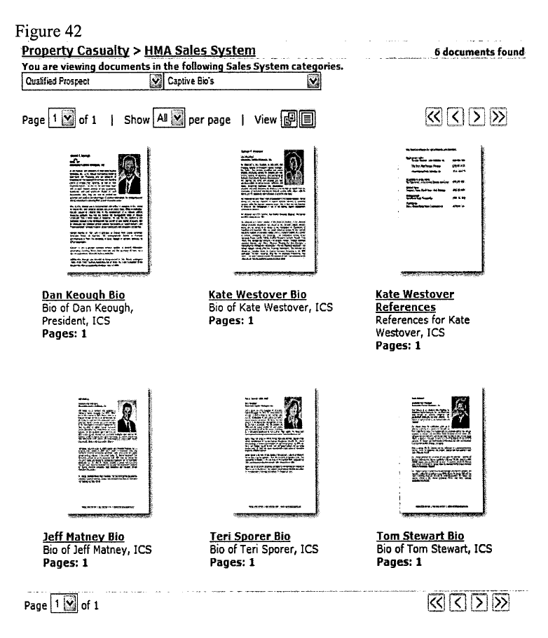

Selecting the captive bios option from the drop down menu associated with the qualified prospect sub-step of the create credibility step displays the screen shown in FIG. 42. This screen displays information relevant to the preferred embodiment of the invention, namely insurance brokerage services. In particular, the screen displays biographical information from people associated with captive insurance firms that may be helpful to prospective clients interested in this type of specific insurance service.

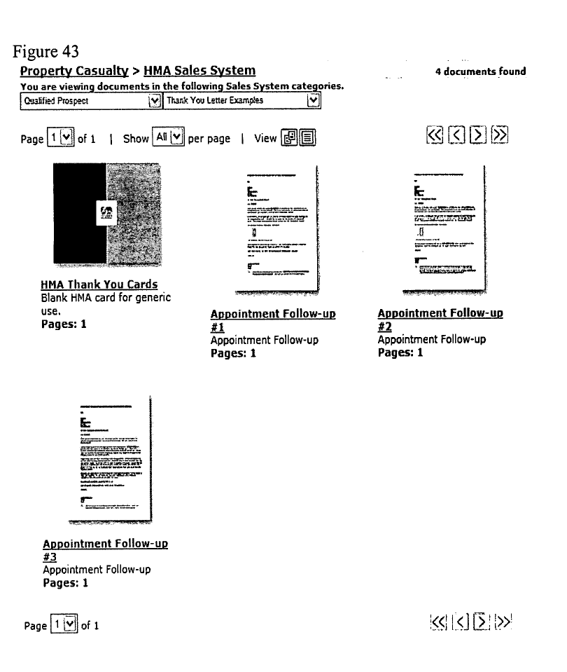

Selecting the thank you letter examples item from the drop down menu associated with the qualified prospect sub-step of the create credibility step displays the screen shown in FIG. 43. This screen displays examples of thank you and reminder forms that can be prepared for submission to a prospective client.

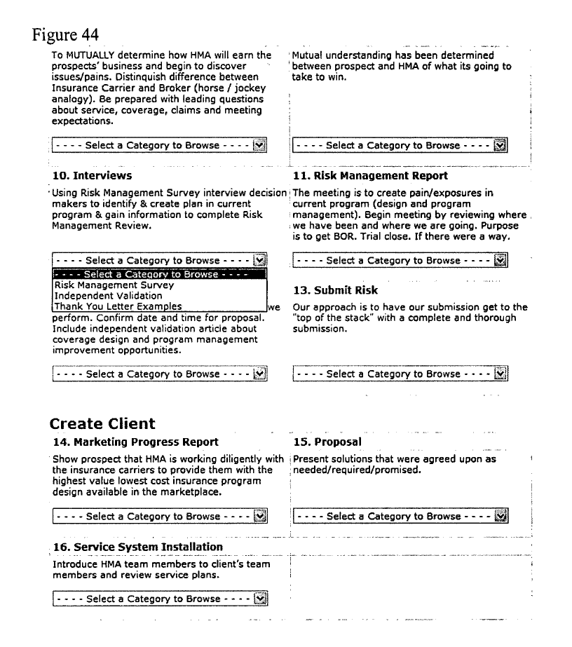

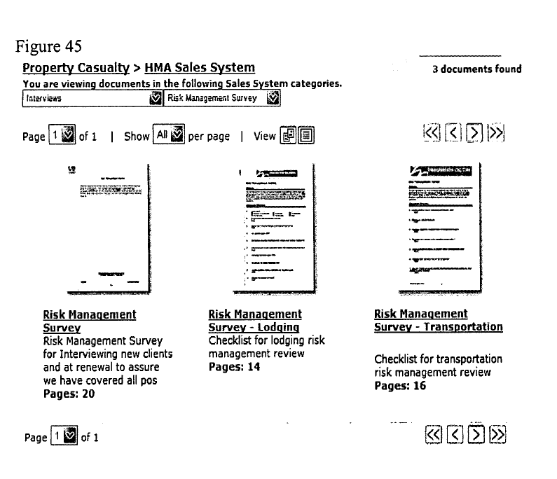

FIG. 44 displays the interviews sub-step of the create credibility step. The interview step focuses on solicitation of information necessary for creating the risk management report, associated with the preferred embodiment of the invention. In particular, selecting the risk management survey item from the drop down menu associated with the interview sub-step of the create credibility step displays the screen shown in FIG. 45. This screen displays prepared materials that can be submitted to a prospective client for the purpose of soliciting information necessary to prepare a risk management report.

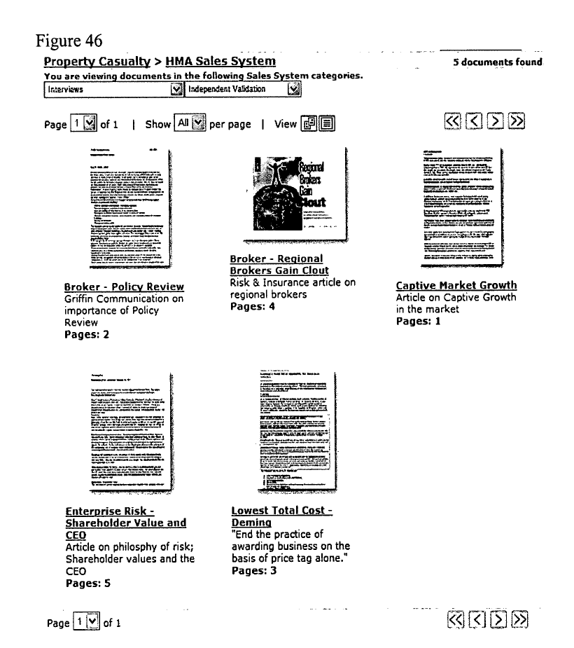

Selecting the independent validation item from the drop down menu associated with the interviews sub-step of the create credibility step displays the screen shown in FIG. 46. The screen gathers together information about specific tactics, strategies, policies, and methodologies that can be provided to a prospective client to assist in the process of evaluating the business services of the offering firm.

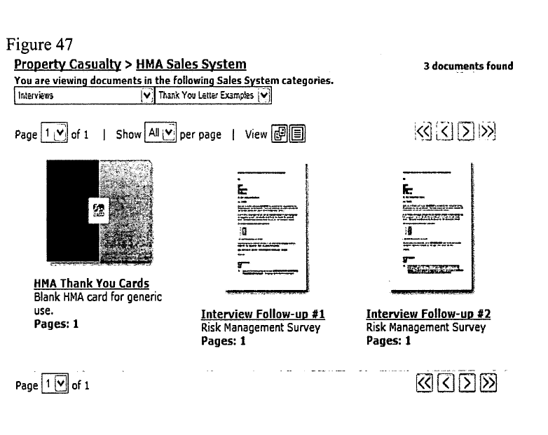

Selecting the thank you letters examples item from the drop down menu associated with the interviews sub-step of the create credibility step displays the screen shown in FIG. 47. This screen displays thank you cards and forms that can be used for follow up and reminder items for submission to the prospective client or for use by the offering firm.

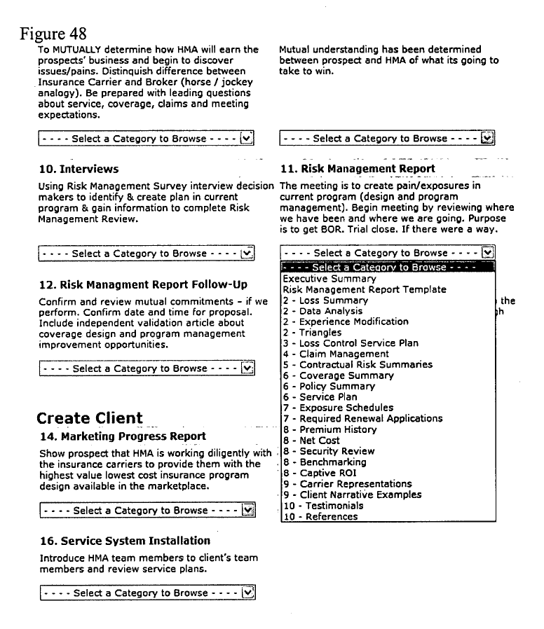

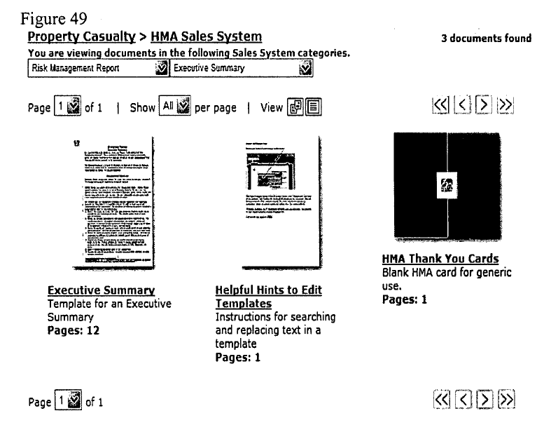

FIG. 48 displays a risk management report sub-step of the create credibility step. This step gathers together the tools and templates necessary to create a risk management report, which is a report used in the preferred embodiment of the invention. Selecting the executive summary item from the drop down menu associated with the risk management report sub-step of the create credibility step displays the screen shown on FIG. 49. This screen displays templates of risk management reports, executive summaries, and some suggestions on preparation of reports and summaries, and any other information that may be helpful in this step of the process.

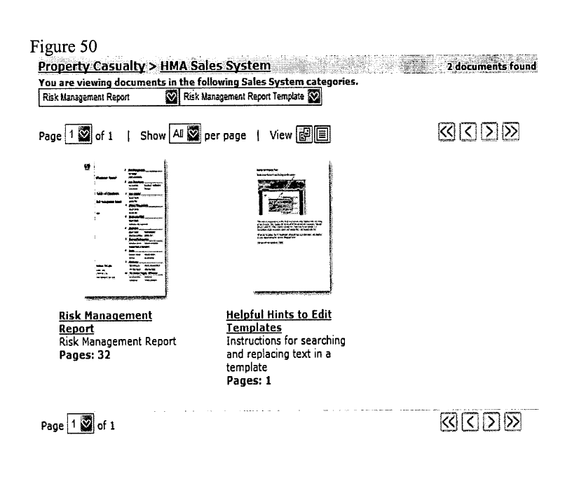

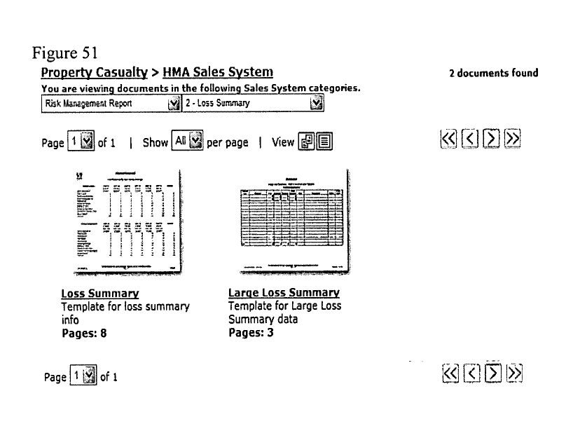

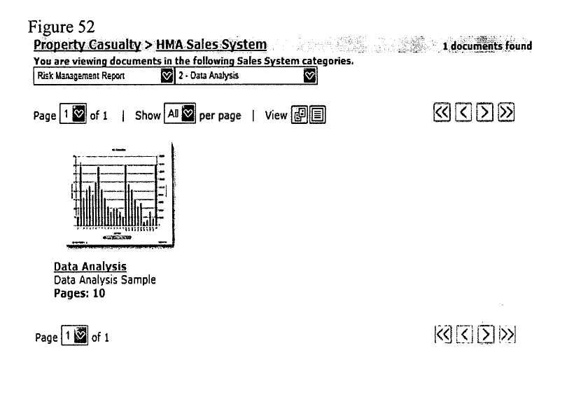

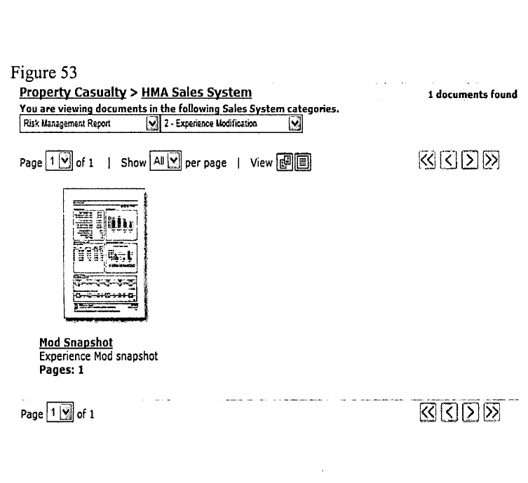

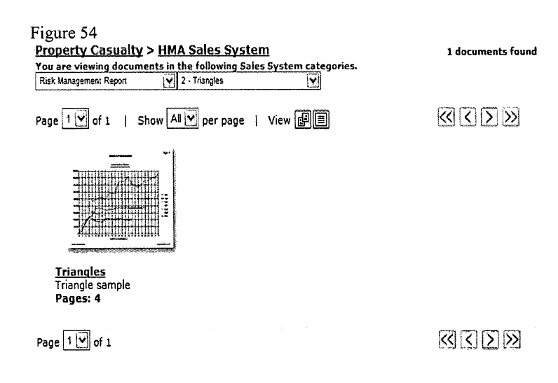

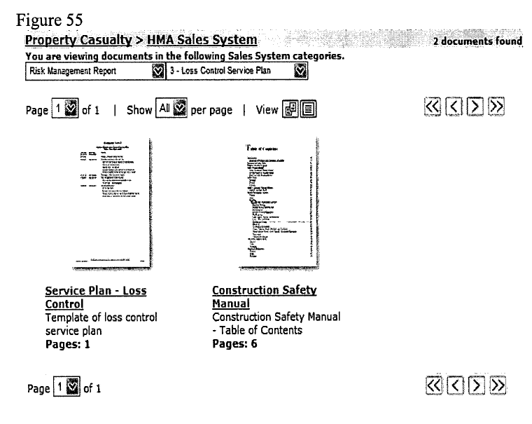

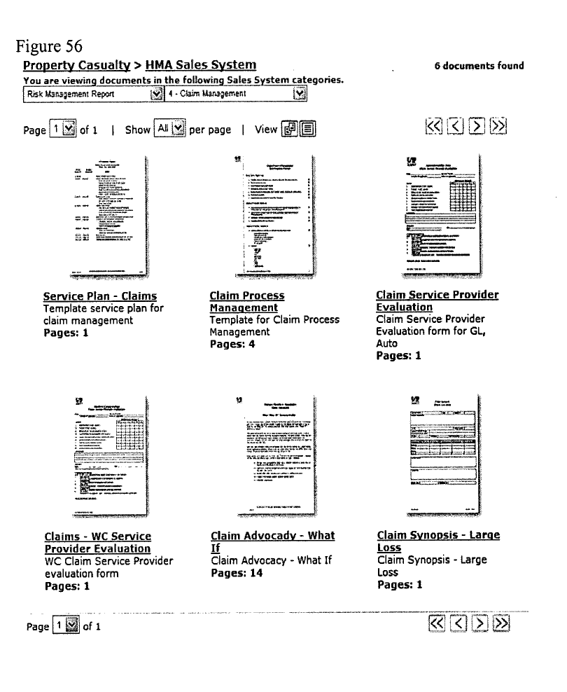

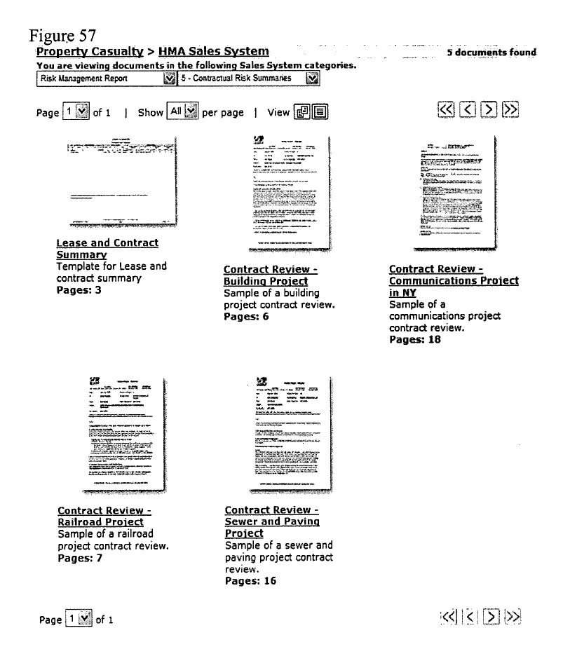

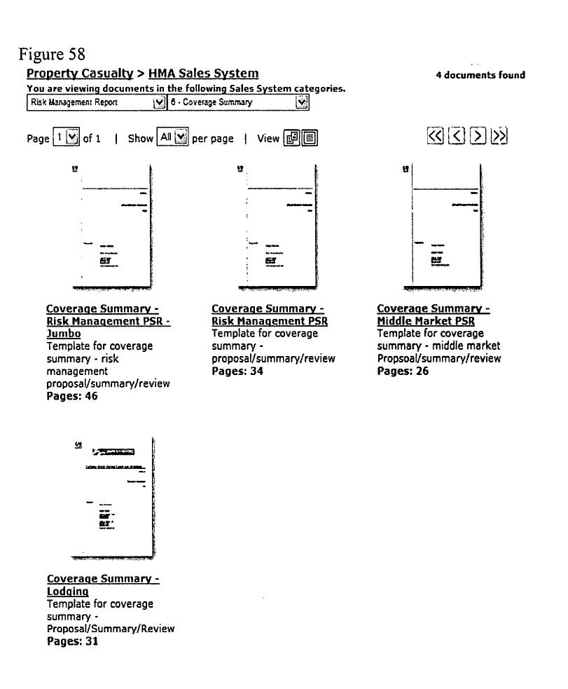

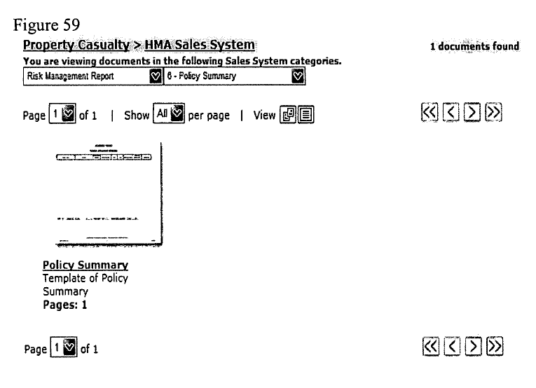

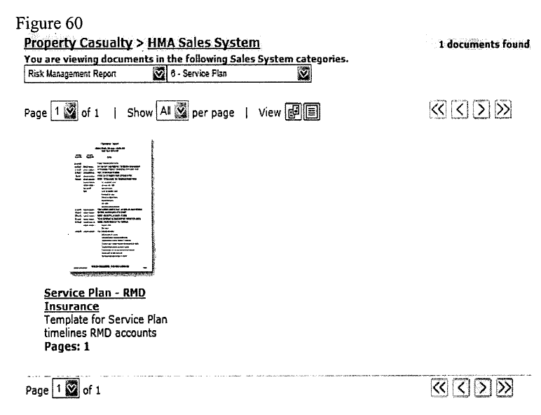

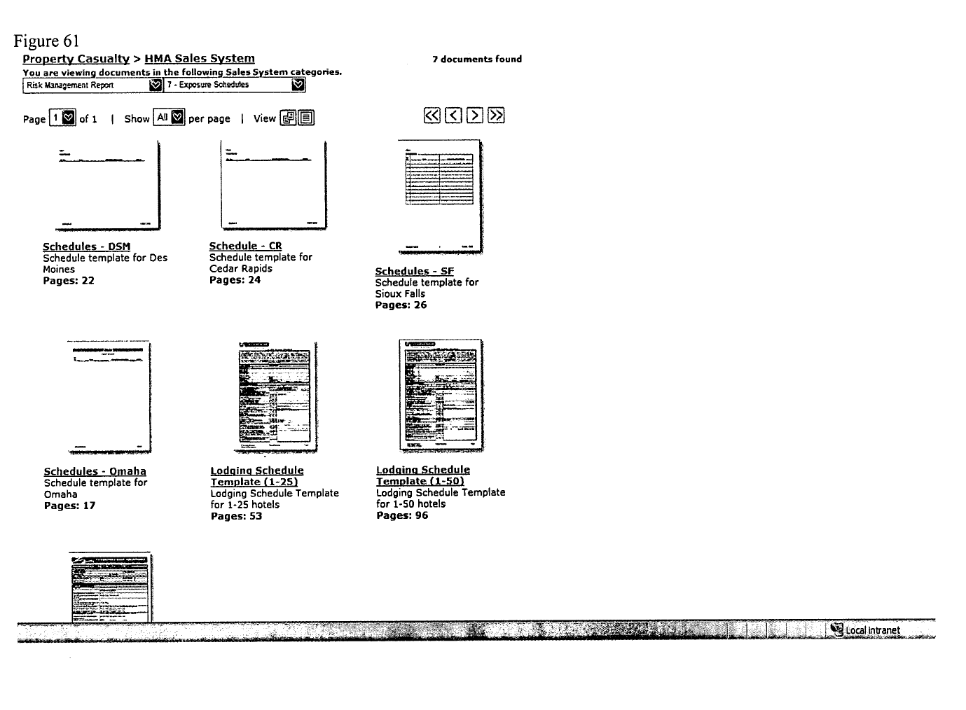

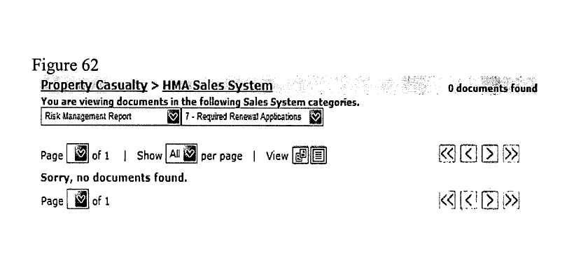

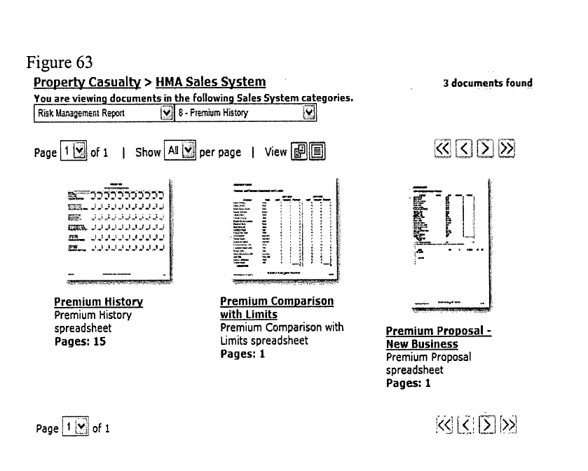

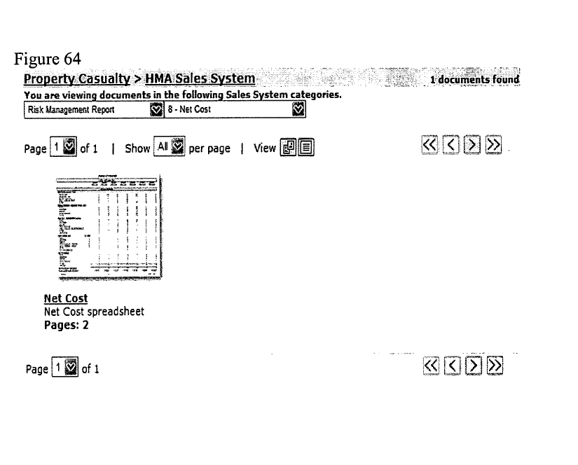

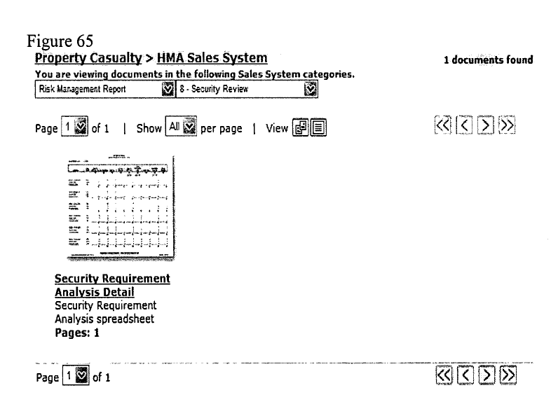

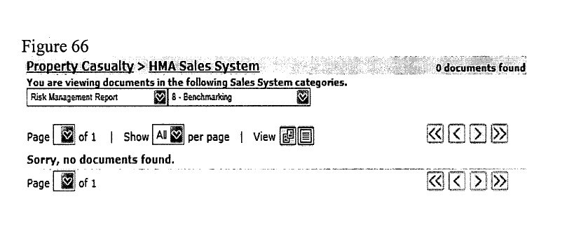

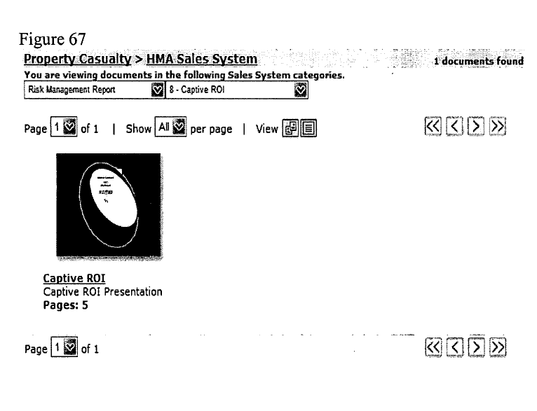

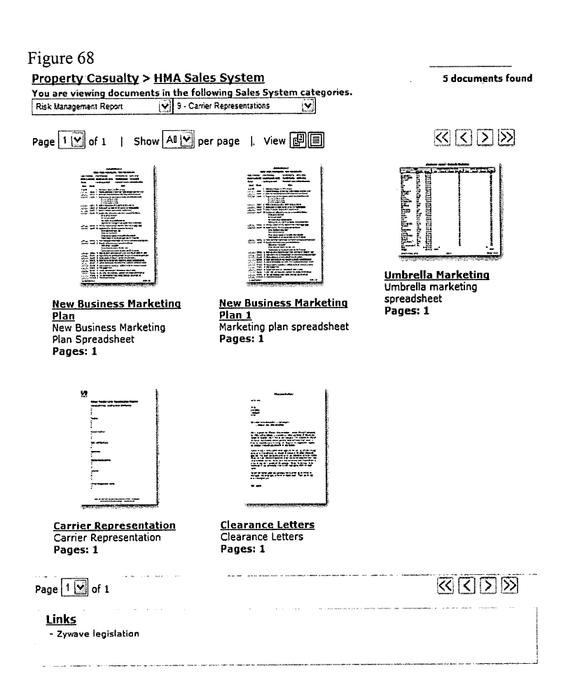

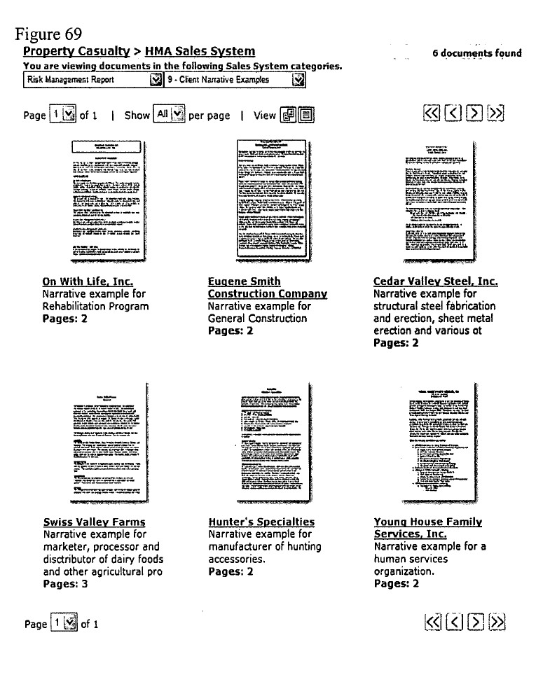

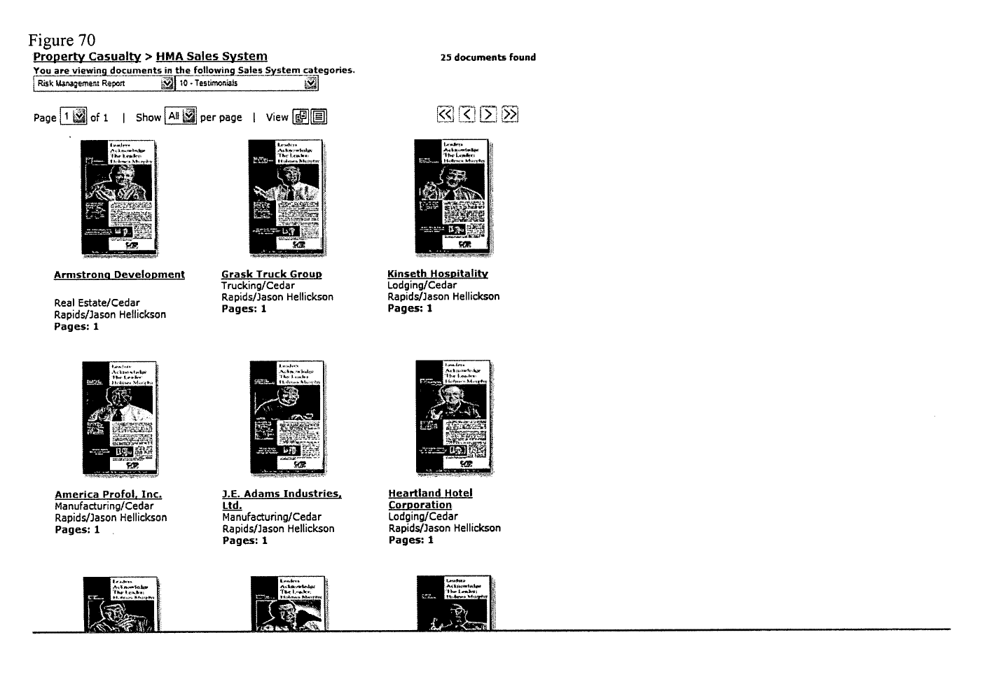

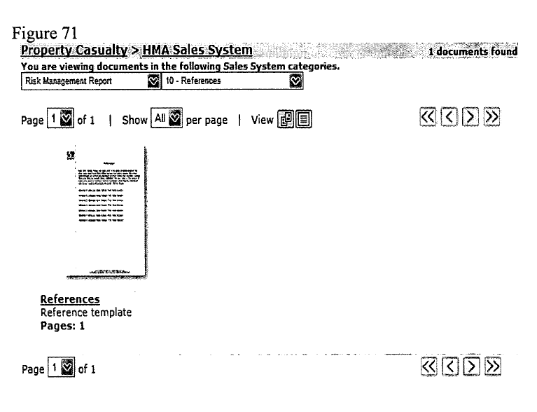

Selecting the risk management report template item from the risk management report sub-step of the create credibility step displays the screen shown in FIG. 50. This screen displays basic template risk management report, and information about tips and suggestions for preparation of the reports. In general, risk management is the process of measuring or assessing risk, and then developing strategies to manage the risk. The risk management report is a document prepared by the offering firm on behalf of the prospective client necessary to assess and manage risk. The drop down menu associated with the risk management report sub-step of the create credibility step lists by category typical segments or portions of a risk management report. Selecting any of these items will display an associated screen (shown in FIGS. 51-71). Each screen gathers together templates, summaries, examples, and suggestions useful in preparing the particular segment of the risk management report. Those of ordinary skill in the art will understand the nature and applicability of the information displayed in FIGS. 51-71, and the application of such information to the processes and methods of the present invention.

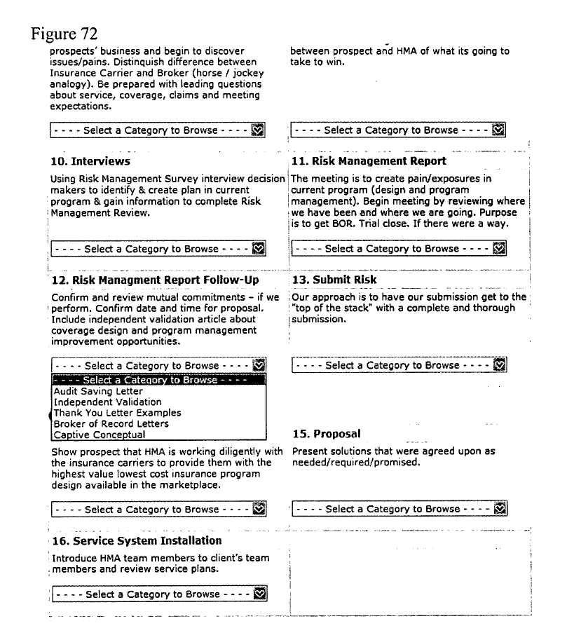

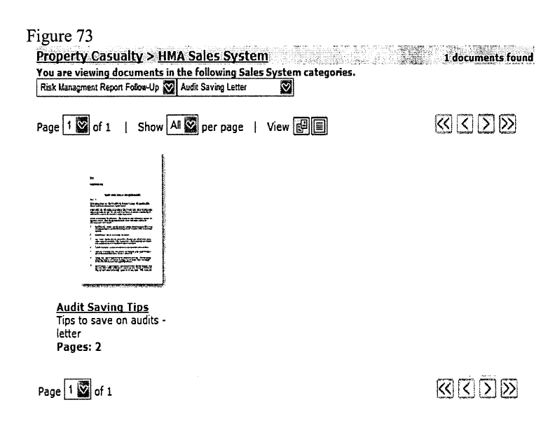

FIG. 72 displays the risk management report follow up sub-step of the create credibility step. This step gathers together the tools and information that the offering firm would use after the risk management report has been prepared and forwarded to the prospective client. In particular, selecting the audit savings letter item from the drop down menu associated with the risk management report follow up sub-step of the create credibility step displays the screen shown in FIG. 73. This screen displays information useful in helping the prospective client prepare for upcoming audits associated with the risk management report process. The information will assist the client in saving time and money in the audit process, thereby building credibility in the offering firm.

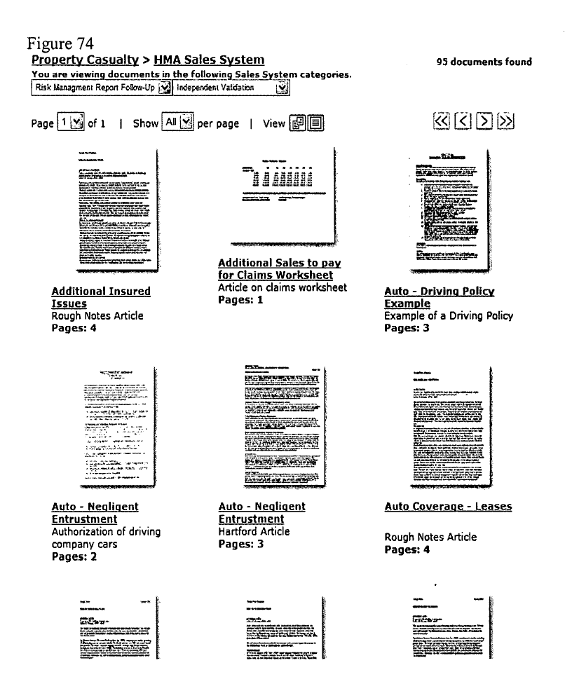

Selecting the independent validation item from the drop down menu associated with the risk management report follow up sub-step of the create credibility step displays the screen shown in FIG. 74. This screen displays information that may be useful for the prospective client in independently validating coverage design and program management improvement opportunities. These articles can be specifically tailored to the prospective clients business, or provide more general information.

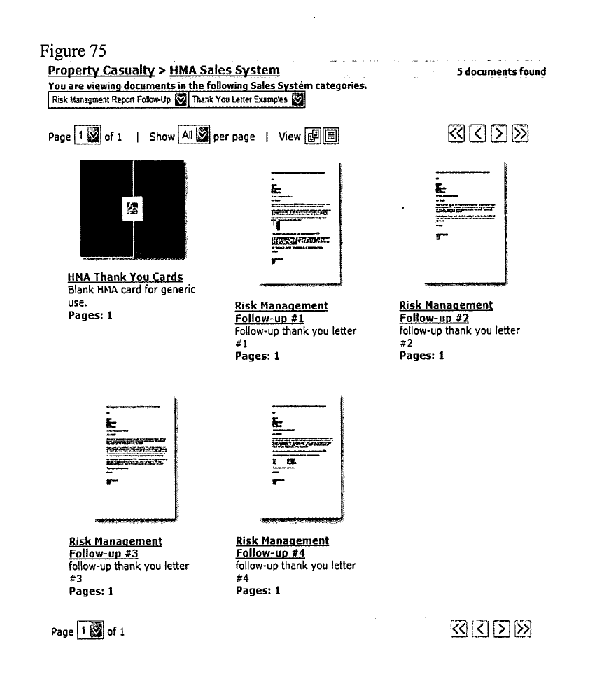

Selecting the thank you letter examples item from the drop down menu associated with the risk management report follow up sub-step of the create credibility step displays the screen shown in FIG. 75. This screen displays thank you letters, and specific template examples of follow up responses to the risk management report.

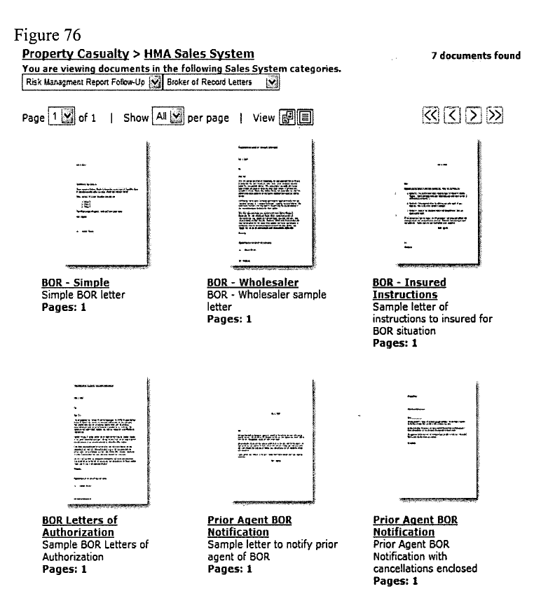

Selecting the broker of record letters item from the drop down menu associated with the risk management report follow up sub-step of the create credibility step displays the screen shown in FIG. 76. This screen displays several examples of broker of record letters that can be used with the prospective client. Broker of record letters are an example of a document associated with a preferred embodiment of the invention, namely insurance brokerage services. A broker of record letter is a letter submitted by the broker on behalf of the insured to the insurer.

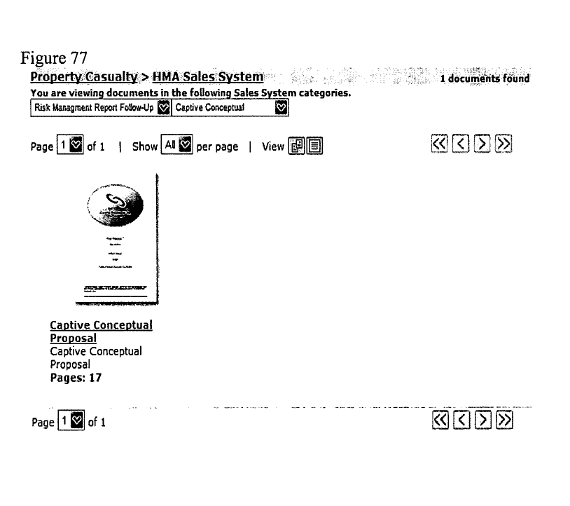

Selecting the captive conceptual item from the drop down menu associated with the risk management follow up sub-step of the create credibility step displays the screen shown in FIG. 77. This screen displays information relevant to the preferred embodiment of the invention, namely information about captive insurance services.

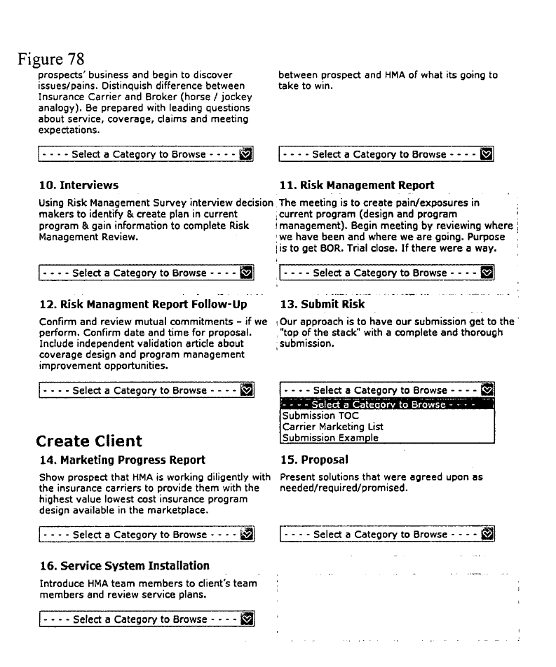

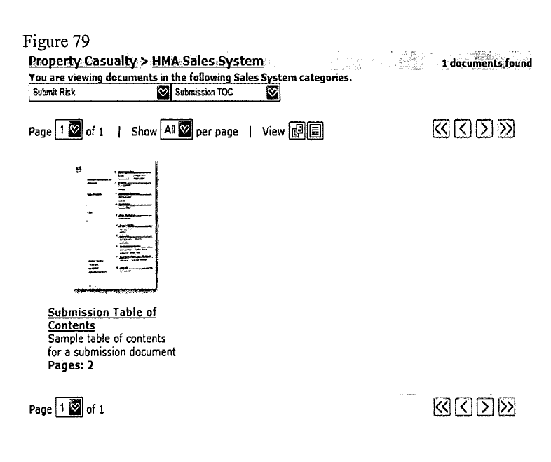

FIG. 78 displays the submit risk sub-step of the create credibility step. This step gathers together the tools and information needed to submit the risk management report to a particular carrier for evaluation. In particular, selecting the submission TOC item from the drop down menu associated with the submit risk sub-step of the create credibility step displays the screen shown in FIG. 79. This screen displays sample templates of table of contents that can be used in association with submission of the risk management report.

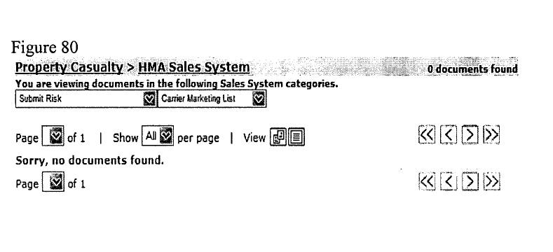

Selecting the carrier marketing list displays the screen shown in FIG. 80. The carrier marketing list is particular to the preferred embodiment of the invention, and is a list of insurances carriers that the offering firm is associated with, or offers the services of. This information can be used useful in the solicitation/preparation process.

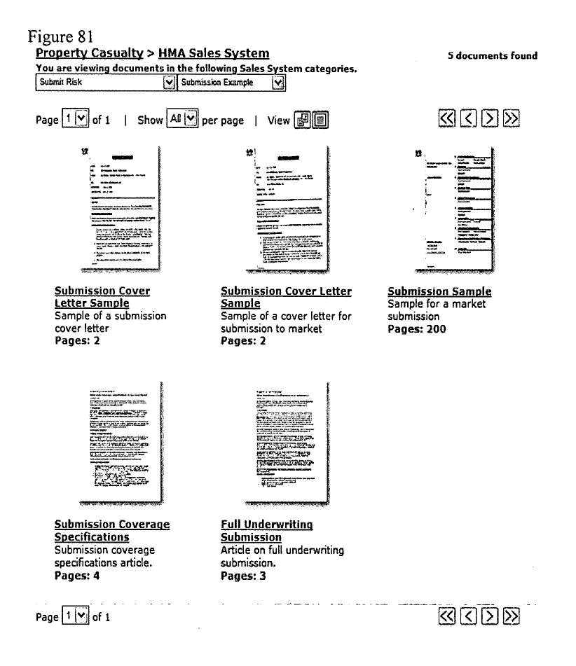

Selecting the submission example item from the drop down menu associated with the submit risk sub-step of the create credibility step displays the screen shown in FIG. 81. This screen displays examples of cover letters, submission specifications, and other information that may be useful in either submitting the risk management report or in explaining the same to the prospective client.

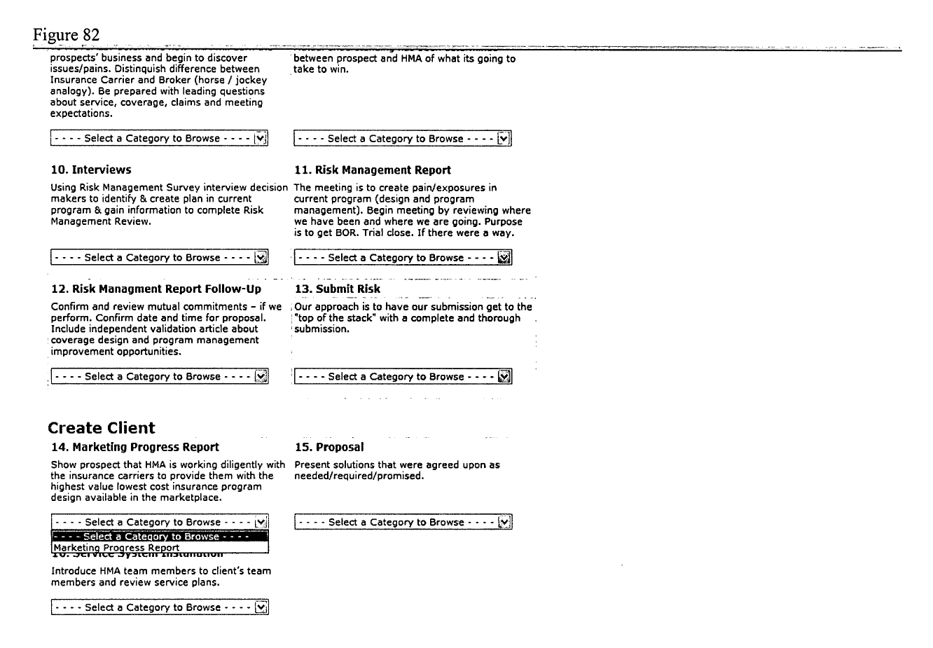

FIG. 82 displays the next step in the process of the present invention which is the create client step. In this step the offering firm performs the tasks and prepares materials to transition from a prospective relationship to a client relationship. These steps include documenting progress with a particular client, preparing specific proposal information, and introducing the offering firms personnel to the prospective client. In particular, FIG. 82 displays the marketing progress report sub-step of the create client step. This sub-step involves gathering together tools and information that can be useful in demonstrating to the prospective client progress made in the process of solicitation and development of a client relationship.

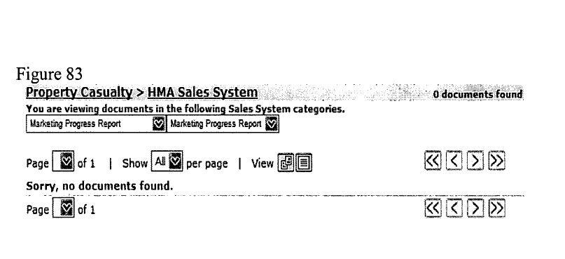

Selecting the marketing progress report item from the drop down menu associated with the marketing progress report sub-step of the create client step displays the screen shown in FIG. 83. This screen can be used to display templates, reports, and other information that would be helpful to show to a prospective client the status of efforts of the marketing firm made on behalf of the prospective client. This could include progress reports, status reports, or other items demonstrating the efforts of the offering firm.

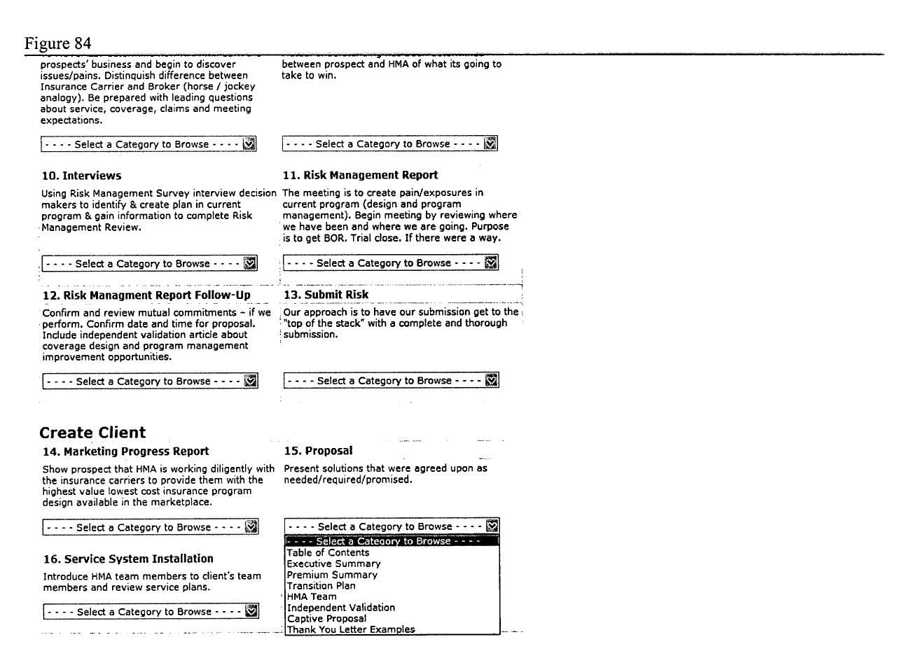

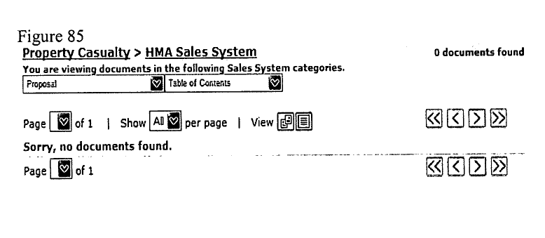

FIG. 84 displays the proposal sub-step of the create client step. This step groups together information helpful in preparing specific proposals and plans that the offering firm can forward to the prospective client after the risk management report has been approved. In particular, selecting the table of contents item from the drop down menu associated with the proposal sub-step of the create client step displays of the screen shown in FIG. 85. This screen can be used to display sample templates of proposal table of contents. Examples of proposal table of contents might include the following, executive summary, insurance, loss experience, costs, renewal information, transition and service plans, team members.

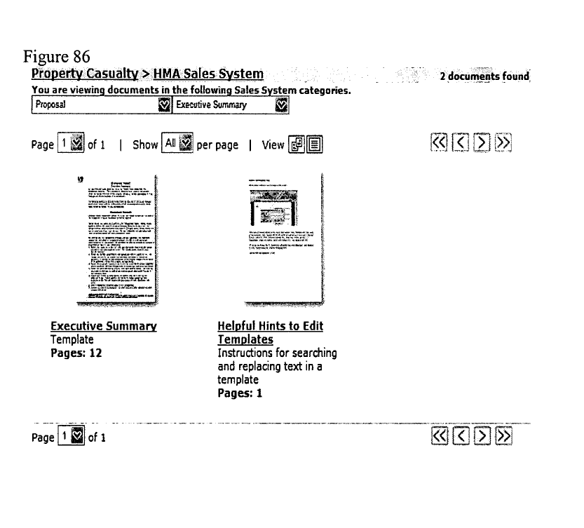

Selecting the executive summary item from the drop down menu associated with the proposal sub-step of the create client step displays the screen shown in FIG. 86. The screen displays sample template executive summaries, and hints and aides for preparation of executive summaries that can be incorporated into a proposal to a prospective client.

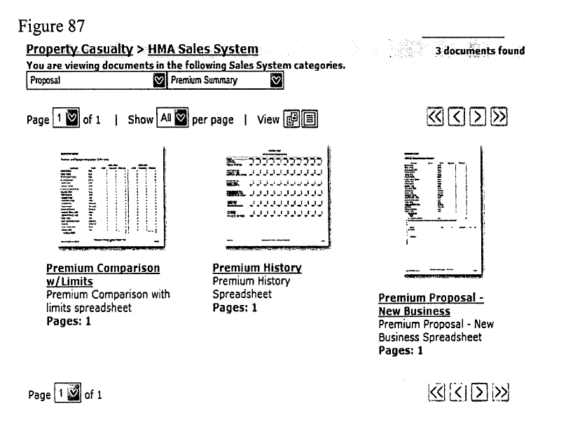

Selecting the premium summary item from the drop down menu associated with the proposal sub-step of the create client step displays the screen shown in FIG. 87. This screen displays samples of information that can be used to display proposal information in a spreadsheet format.

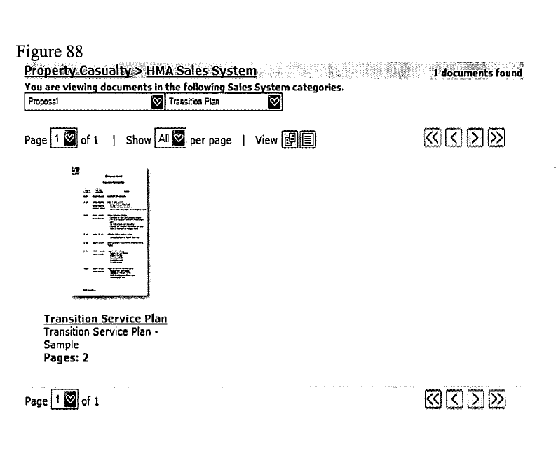

Selecting the transition plan item from the drop down menu associated with the proposal sub-step of the create client step displays a screen shown in FIG. 88. The screen can be used to display examples of transition service plans that can be used in the preparation of a proposal to a prospective client.

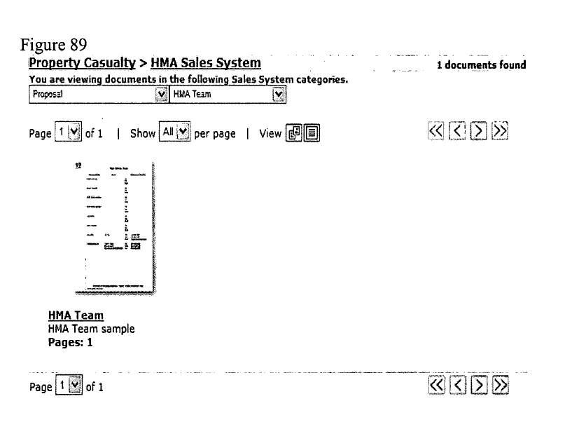

Selecting the team item from the drop down menu associated with the proposal sub-step of the create client step displays the screen shown in FIG. 89. This screen includes information about the members of the client organization that will be assigned to the prospective client, in a form that can be included in the prospective client proposal.

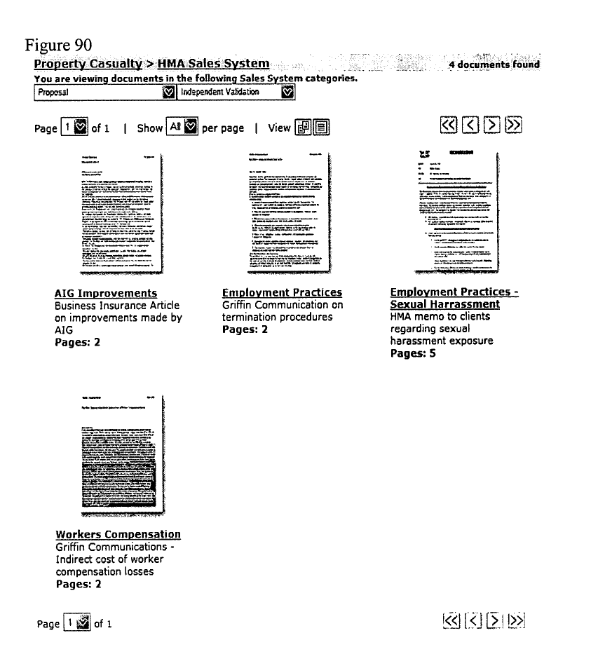

Selecting the independent validation item from the drop down menu associated with the proposal sub-step of the create client step displays the screen shown in FIG. 90. This screen displays information that may be useful for the prospective client in independently validating coverage design and program management improvement opportunities. These articles can be specifically tailored to the prospective clients business, or provide more general information.

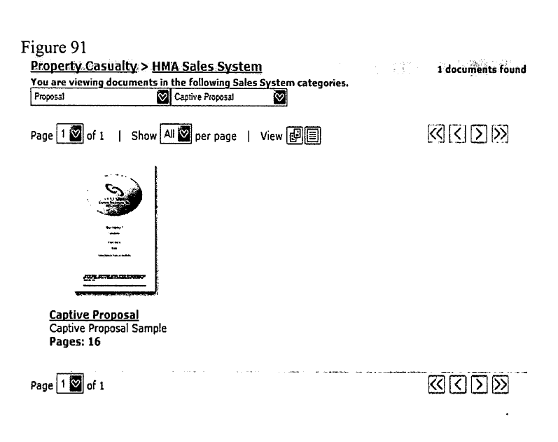

Selecting the captive proposal item from the drop down menu associated with the proposal sub-step of the create client step displays the screen shown in FIG. 91. This screen shows information/templates about captive insurance services that can be provided to the prospective client.

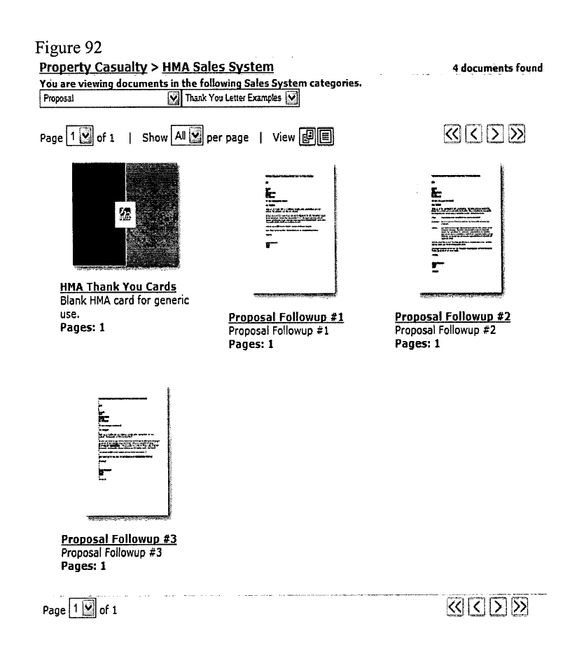

Selecting the thank you letter examples item from the drop down menu associated with the proposal sub-step of the create client step displays the screen shown in FIG. 92. This screen shows examples of thank you letters, cards, and follow up proposal information that can be provided to the prospective client.

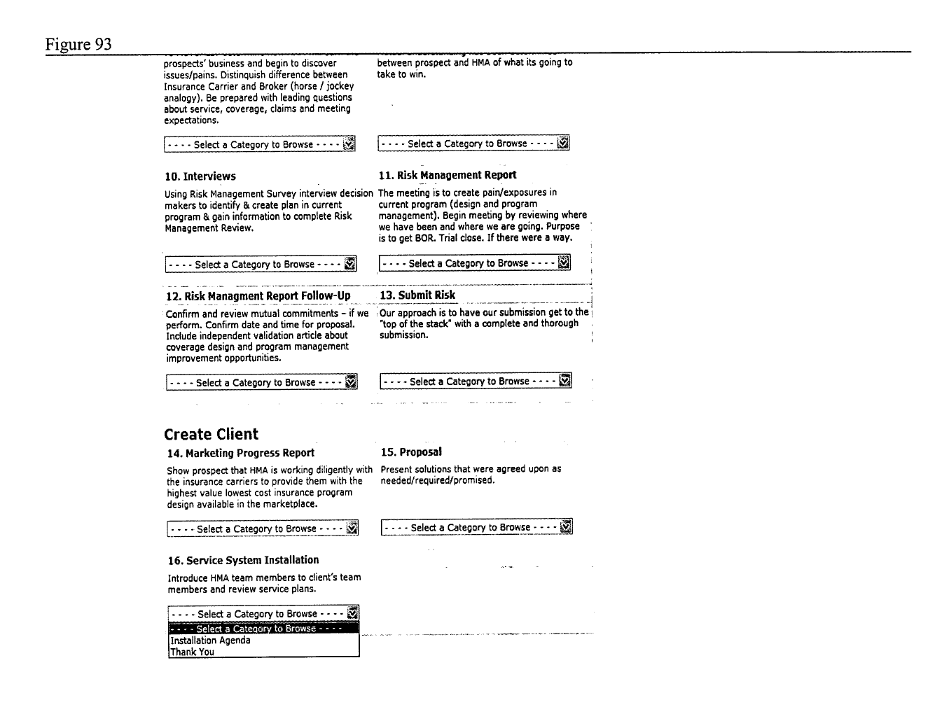

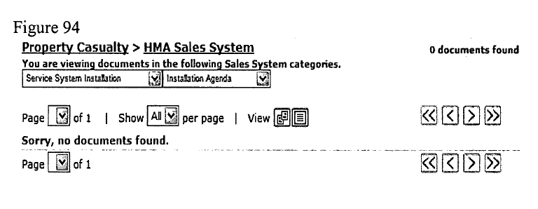

FIG. 93 displays the service system installation sub-step of the client step. The service system installation sub-step gathers together the tools and reference materials helpful in implementing an approved proposal plan to a prospective client, and introducing them to the members of the offering organizations staff who will be servicing the client. In particular, selecting the installation agenda item from the drop down menu associated with the service system installation sub-step of the create client step displays the screen shown in FIG. 94. This screen can be used to display template and example agendas to be used in meetings or presentation to the prospective client. The meeting of the proposal can present information about the implementation or installation of the agreed upon services. The agendas would include such items as introduction of the offering organizations personnel and functions, a review of the service plan, and specific details of services to be offered.

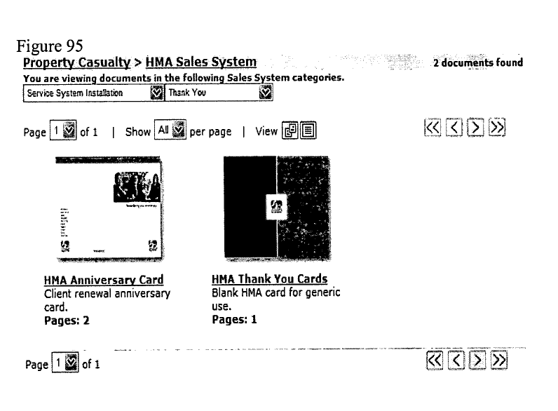

Selecting the thank you item from the drop down menu associated with the service system installation sub-step of the create client step displays the screen shown in FIG. 95. This screen displays the examples and templates of thank you and reminder cards that can be forwarded to the client organization as appropriate.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention.

1. A computerized sales system comprising:
a general purpose computer system for performing the steps of said method in accordance with programming code operating on said computer;
a graphical user interface for display of information and materials to a user of said system;
a preparation step area of said graphical user interface for collection and presentation of tools and material intended for use in preparing for solicitation of a client by an offering firm;
an open door step area of said graphical user interface for collection and presentation of tools and material intended for use in approaching said client or solicitation by said offering firm;
a create credibility step area of said graphical user interface for collection and presentation of tools and materials intended of use in building credibility in said offering firm from the perspective of said client; and
a create client step area of said graphical user interface for collection and presentation of tools and materials intended of use in creating a client relationship with said client.

2. The system in accordance with claim 1 wherein said offering firm is offering services.

3. The system in accordance with claim 2 wherein said offering firm is offering insurance services.

4. The system in accordance with claim 1 wherein said preparation step area further includes a company story sub-step area for collection and presentation of tools and materials intended of use in introducing said prospective client to said offering firms history;
a value proposition sub-step area for collection and presentation of tools and materials intended of use in defining the value of said offering firm to said prospective client;
an independent validation sub-step area for collection and presentation of tools and materials intended of use in introducing relevant third-party information to said prospective customer;
a request for proposal sub-step area for collection and presentation of tools and materials intended of use in soliciting from said prospective client information to create a request for proposal for the prospective client; and
a suspect management sub-step area for collection and presentation of tools and materials intended of use in managing a list of prospective clients.

5. The system in accordance with claim 1 wherein said open door step area further includes a pre-approach sub-step area for collection and presentation of tools and materials intended of use in educating said prospective client on said offering firms reputation; and
an approach sub-step area for collection and presentation of tools and materials intended of use in approaching said prospective client.

6. The system in accordance with claim 1 wherein said create credibility step area includes an appointments sub-step area for collection and presentation of tools and materials intended of use in getting acquainted with said prospective client, for determining methods of communication, and for distinguishing said offering firm;
a qualified prospects sub-step area for collection and presentation of tools and materials intended of use setting expectations of performance;
an interviews sub-step area for collection and presentation of tools and materials intended of use in interview and collect information from prospective client to create a risk management report;
a risk management report sub-step area for collection and presentation of tools and materials intended of use in creating said risk management report;
a risk management report follow-up sub-step area for collection and presentation of tools and materials intended of use in defining commitments and responsibilities after creating of said risk management report; and
a submit risk sub-step area for collection and presentation of tools and materials intended of use in submission of said risk management report.

7. The system in accordance with claim 1 wherein said create client step area includes a marketing progress report for collection and presentation of tools and materials intended of use in documenting progress in the process of solicitation;
a proposal sub-step area for collection and presentation of tools and materials intended of use presenting a proposal to said prospective client; and
a installation of service system sub-step area for collection and presentation of tools and materials intended of use introduction of key personal of said offering firm and for reviewing plans for providing services to said client.
